(19) United States
(12) Patent Application Publication
(10) Pub. No.: US 2026/0109340 A1
(43) Pub. Date: Apr. 23, 2026

(54) BRAKE DEVICE AND CONTROL METHOD THEREOF

(71) Applicant: HL MANDO CORPORATION, Pyeongtaek (KR)

(72) Inventors: Seongnam KIM, Pyeongtaek (KR); Byoungjin PARK, Pyeongtaek (KR)

(21) Appl. No.: 19/223,479

(22) Filed: May 30, 2025

(30) Foreign Application Priority Data
Oct. 17, 2024 (KR) KR10-2024-0141905

(51) Int. Cl. B60W 30/02; B60W 10/08; B60W 10/184; B60W 10/20; B60W 30/18

(52) U.S. Cl. CPC B60W 30/02; B60W 10/08; B60W 10/184; B60W 10/20; B60W 30/18127; B60W 2510/083; B60W 2510/18; B60W 2520/406; B60W 2540/12; B60W 2710/083; B60W 2710/202

(57) ABSTRACT

A brake device according to an aspect of the present disclosure includes a brake module associated with braking of each of right and left wheels of a first axle of a vehicle, a brake module associated with braking of each of right and left wheels of a second axle of the vehicle, and a controller configured to control the brake modules based on a pedal signal associated with movement of a brake pedal. The controller, based on identifying a failure of at least one of the brake modules, requests regenerative braking of a wheel associated with a brake module with failure from a driving device of the vehicle and controls a braking torque of a brake module without failure, and based on braking torques applied to the left wheels being different from braking torques applied to the right wheels, requests a steering device of the vehicle to steer the vehicle.

### CROSS-REFERENCE TO RELATED APPLICATIONS

This application claims the priority of Korean Patent Application No. 10-2024-0141905 filed on Oct. 17, 2024, in the Korean Intellectual Property Office, the disclosure of which is incorporated herein by reference.

### BACKGROUND

### Field

The present disclosure relates to an electromechanical brake device and a control method thereof.

### Description of the Related Art

Vehicles are essentially equipped with a brake device to perform braking, and various brake devices are being proposed to brake the vehicle in order to ensure the safety of drivers and passengers.

A hydraulic brake device includes a wheel cylinder provided on each wheel of the vehicle. The hydraulic brake device generates hydraulic pressure in response to a required braking force of a driver and provides the generated hydraulic pressure to the wheel cylinder. Braking torque may be provided to the wheels of the vehicle by the hydraulic pressure provided to the wheel cylinder.

An electromechanical brake device includes a braking motor provided for each wheel of a vehicle. The electromechanical brake device transmits an electrical signal to the braking motor in response to a required braking force of a driver. The motor may mechanically provide a braking torque to the wheel of the vehicle according to the received electrical signal.

Unlike the hydraulic brake device, in the electromechanical brake device, the brake device that provides the braking torque to the wheel and a control device that controls the brake device are not hydraulically or mechanically connected to each other. As a result, the electromechanical brake device is more susceptible to damage or errors of an actuator or control/drive circuit.

### SUMMARY

An object of the present disclosure is to provide an electromechanical brake device and a control method thereof capable of responding to damage or errors in an actuator or control/drive circuit through cooperation with other devices of a vehicle.

Another object of the present disclosure is to provide an electromechanical brake device and a control method thereof capable of responding to damage or errors in an actuator or control/drive circuit through cooperation with a driving device of a vehicle.

Still another object of the present disclosure is to provide an electromechanical brake device and a control method thereof capable of responding to damage or errors in an actuator or control/drive circuit through cooperation with a steering device of a vehicle.

According to according to one aspect of the present disclosure, there is provided a brake device including: a brake module associated with braking of each of right and left wheels of a first axle of a vehicle; a brake module associated with braking of each of right and left wheels of a second axle of the vehicle; and a controller configured to control the brake modules based on a pedal signal associated with movement of a brake pedal. The controller, based on identifying a failure of at least one of the brake modules, requests regenerative braking of a wheel associated with a brake module with failure from a driving device of the vehicle and controls a braking torque of a brake module without failure, and based on braking torques applied to the left wheels being different from braking torques applied to the right wheels, requests a steering device of the vehicle to steer the vehicle.

The controller may obtain a driver required braking torque based on the pedal signal, obtain a maximum regenerative braking torque of the driving device, and request a regenerative braking torque from the driving device based on whether the driver required braking torque is less than or equal to the maximum regenerative braking torque.

The controller requests the driving device to apply a regenerative braking torque corresponding to the driver required braking torque to the wheel associated with the brake module with failure, based on the driver required braking torque being less than or equal to the maximum regenerative braking torque.

The controller may control the brake module without failure to apply a braking torque corresponding to the driver required braking torque, based on the driver required braking torque being less than or equal to the maximum regenerative braking torque.

The controller may request the driving device to apply a regenerative braking torque corresponding to the maximum regenerative braking torque to the wheel associated with the brake module with failure, based on the driver required braking torque exceeding the maximum regenerative braking torque.

The controller may control the brake module without failure to apply a braking torque corresponding to a difference between the driver required braking torque and the maximum regenerative braking torque, based on the driver required braking torque being less than or equal to the maximum regenerative braking torque.

The controller may request the steering device of the vehicle to steer the vehicle, based on the brake module with failure including two brake modules provided on the same side of a different axle.

The controller may not request the steering device of the vehicle to steer the vehicle, based on the brake module with failure including two brake modules provided on a different side of a different axle.

According to another aspect of the present disclosure, there is provided a control method of a brake device including a brake module associated with braking of each of right and left wheels of a first axle of a vehicle and a brake module associated with braking of each of right and left wheels of a second axle of the vehicle, the control method including: based on identifying a failure of at least one of the brake modules, requesting regenerative braking of a wheel associated with a brake module with failure from a driving device of the vehicle and controlling a braking torque of a brake module without failure; and based on braking torques applied to the left wheels being different from braking torques applied to the right wheels, requesting a steering device of the vehicle to steer the vehicle.

The requesting of the regenerative braking of the wheel associated with the brake module with failure may include obtaining a driver required braking torque based on the pedal signal, obtaining a maximum regenerative braking torque of the driving device, and requesting a regenerative braking torque from the driving device based on whether the driver required braking torque is less than or equal to the maximum regenerative braking torque.

The requesting of the regenerative braking torque from the driving device may include requesting the driving device to apply a regenerative braking torque corresponding to the driver required braking torque to the wheel associated with the brake module with failure, based on the driver required braking torque being less than or equal to the maximum regenerative braking torque.

The controlling of the braking torque of the brake module without failure may include controlling the brake module without failure to apply a braking torque corresponding to the driver required braking torque, based on the driver required braking torque being less than or equal to the maximum regenerative braking torque.

The requesting of the regenerative braking torque from the driving device may include requesting the driving device to apply a regenerative braking torque corresponding to the maximum regenerative braking torque to the wheel associated with the brake module with failure, based on the driver required braking torque exceeding the maximum regenerative braking torque.

The controlling of the braking torque of the brake module without failure may include controlling the brake module without failure to apply a braking torque corresponding to a difference between the driver required braking torque and the maximum regenerative braking torque, based on the driver required braking torque being less than or equal to the maximum regenerative braking torque.

The requesting of the steering device to steer the vehicle may include requesting the steering device of the vehicle to steer the vehicle, based on the brake module with failure including two brake modules provided on the same side of a different axle.

The requesting of the steering device to steer the vehicle may include not requesting the steering device of the vehicle to steer the vehicle, based on the brake module with failure including two brake modules provided on a different side of a different axle.

According to still another aspect of the present disclosure, there is provided a brake device including: a brake module associated with braking of each of right and left wheels of a first axle of a vehicle; a brake module associated with braking of each of right and left wheels of a second axle of the vehicle; and a controller configured to control the brake modules based on a pedal signal associated with movement of a brake pedal. The controller controls, based on identifying a failure of at least one of the brake modules, a braking torque of a brake module without failure, and requests, based on braking torques applied to the left wheels being different from braking torques applied to the right wheels, a steering device of the vehicle to steer the vehicle.

The controller may request the steering device of the vehicle to steer the vehicle, based on identifying a failure of one brake module.

The controller may request the steering device of the vehicle to steer the vehicle, based on the brake module with failure including two brake modules provided on the same side of a different axle.

The controller may not request the steering device of the vehicle to steer the vehicle, based on the brake module with failure including two brake modules provided on a different side of a different axle.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 illustrates a configuration of a vehicle including an electromechanical brake device according to one embodiment of the present disclosure;

FIG. 2 illustrates configurations of an electromechanical brake device and a vehicle related thereto according to one embodiment of the present disclosure;

FIG. 3 illustrates an example of the electromechanical brake according to one embodiment of the present disclosure;

FIG. 4 illustrates an example of a connection relationship between components included in a brake device according to one embodiment of the present disclosure;

FIGS. 5A and 5B illustrate an example of the brake device according to one embodiment of the present disclosure cooperating with a driving device in response to a failure of any one brake module;

FIGS. 6A, 6B, and 6C illustrate an example of the brake device according to one embodiment of the present disclosure cooperating with the driving device and a steering device in response to failure of any two brake modules;

FIGS. 7A and 7B illustrate an example of the brake device according to one embodiment of the present disclosure cooperating with the driving device and the steering device in response to failure of three or more brake modules;

FIGS. 8A and 8B illustrate an example of the brake device according to one embodiment of the present disclosure cooperating with the driving device in response to a failure of any one brake module;

FIGS. 9A, 9B, and 9C illustrate an example of the brake device according to one embodiment of the present disclosure cooperating with the driving device and the steering device in response to failure of any two brake modules;

FIGS. 10A and 10B illustrate an example of the brake device according to one embodiment of the present disclosure cooperating with the driving device and the steering device in response to failure of three or more brake modules;

FIG. 11 illustrates an example of the brake device according to one embodiment of the present disclosure cooperating with the driving device in response to a failure of any one brake module;

FIGS. 12A, 12B, and 12C illustrate an example of the brake device according to one embodiment of the present disclosure cooperating with the driving device and the steering device in response to failure of any two brake modules;

FIGS. 13A and 13B illustrate an example of a brake device according to one embodiment of the present disclosure cooperating with the driving device and the steering device in response to failure of three or more brake modules;

FIG. 14 illustrates an example of the brake device according to one embodiment of the present disclosure cooperating with the driving device in response to a failure of any one brake module;

FIGS. 15A, 15B, and 15C illustrate an example of a brake device according to one embodiment of the present disclosure cooperating with the driving device and the steering device in response to failure of any two brake modules;

FIGS. 16A and 16B illustrate an example of the brake device according to one embodiment of the present disclosure cooperating with the driving device and the steering device in response to failure of three or more brake modules;

FIG. 17 illustrates an example of the brake device according to one embodiment of the present disclosure cooperating with the steering device in response to a failure of any one brake module;

FIGS. 18A, 18B, and 18C illustrate an example of the brake device according to one embodiment of the present disclosure cooperating with the steering device in response to failure of any two brake modules;

FIG. 19 illustrates an example of the brake device according to one embodiment of the present disclosure cooperating with the steering device in response to failure of three or more brake modules;

FIG. 20 illustrates an example of a method in which the brake device according to one embodiment of the present disclosure cooperates with the driving device and the steering device in response to the failure of the brake module;

FIG. 21 illustrates an example of a method in which the brake device according to one embodiment of the present disclosure cooperates with the driving device and the steering device in response to the failure of the brake module; and

FIG. 22 illustrates an example of a method in which the brake device according to one embodiment of the present disclosure cooperates with the steering device in response to the failure of the brake module.

### DETAILED DESCRIPTION OF THE EMBODIMENT

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

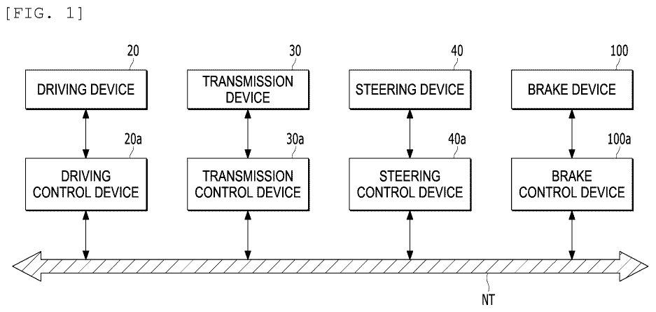

FIG. 1 illustrates a configuration of a vehicle including an electromechanical brake device according to one embodiment of the present disclosure.

A vehicle 1 may include a body that forms the exterior thereof and accommodates a driver and/or luggage, a chassis that includes components of the vehicle 1 other than the body, and wheels that rotate to allow the vehicle 1 to move.

As illustrated in FIG. 1, the vehicle 1 may include a driving device 20, a transmission device 30, a steering device 40, and a brake device 100. The driving device 20, the transmission device 30, and the steering device 40 are not essential components, and all or at least some of them may be omitted. For example, the transmission device 30 may be omitted.

The driving device 20 provides power for driving the vehicle 1 and may drive or accelerate the vehicle 1 in response to detection of a driver's acceleration intention, for example, through an accelerator pedal.

The driving device 20 may include a motor as a driving source for moving the vehicle and a battery that provides energy (electrical energy) to the driving motor as a driving source. For example, an electric vehicle may include a driving motor as a driving source.

While the vehicle 1 is accelerating, the driving motor may receive electric power from the battery and convert the electric power (electrical energy) into rotation (kinetic energy). In addition, the driving motor may convert the rotation (kinetic energy) into electric power (electrical energy) while the vehicle 1 is decelerating or braking, and the electric power may be stored in the battery. In other words, the driving motor may perform regenerative braking for deceleration or braking.

The device for recovering energy is not limited to a driving motor. For example, the driving device 20 may optionally further include an alternator. The alternator may convert rotation (kinetic energy) into electric power (electrical energy) while the vehicle 1 is decelerating or braking. In other words, the alternator may perform regenerative braking for decelerating or braking.

Optionally, the driving device 20 may further include an internal combustion engine (engine). For example, a hybrid vehicle may include both a driving motor and an internal combustion engine (engine) as driving sources.

In this way, the driving device 20 may include only a motor, or may include a motor and optionally an internal combustion engine, and may drive or accelerate the vehicle 1, as well as decelerate or brake the vehicle 1 as appropriate.

The driving device 20 may include a driving control device 20a that controls a driving motor. The driving control device 20a may control the driving device 20 in response to a driver's acceleration intention via an accelerator pedal. For example, the driving control device 20a may control the rotational speed and/or torque of the driving device 20, and may also control regenerative braking by the driving motor 10.

The transmission device 30 may include a plurality of gears and transmit power generated by the driving device 20 to the wheels.

The transmission device 30 may include a transmission control unit (TCU) 30a. The transmission control device 30a may control the transmission device 30 in response to a driver's shift command via a shift lever and/or a traveling speed of the vehicle 1. For example, the transmission control device 30a may control a shift ratio from the driving device 20 to the wheels.

The steering device 40 may change the traveling direction of the vehicle 1 and, for example, may steer the vehicle 1 in response to detection of a driver's steering intention through the steering wheel.

The steering device 40 may include a steering control device 40a. The steering control device 40a may assist the operation of the steering device 40 in response to the driver's steering intention through the steering wheel.

The brake device 100 may provide braking power for the vehicle 1 to brake, and decelerate or stop the vehicle 1 in response to, for example, a driver's braking intention via a brake pedal and/or a request from a traveling assistance device.

The brake device 100 may include a braking control device 101a. The braking control device 101a may control the brake device 100 in response to a driver's braking intention via the brake pedal and/or the behavior of the vehicle 1.

The driving device 20, transmission device 30, steering device 40, and brake device 100 may exchange data through a vehicle communication network NT such as Ethernet, media oriented systems transport (MOST), Flexray, a controller area network (CAN), and a local interconnect network (LIN).

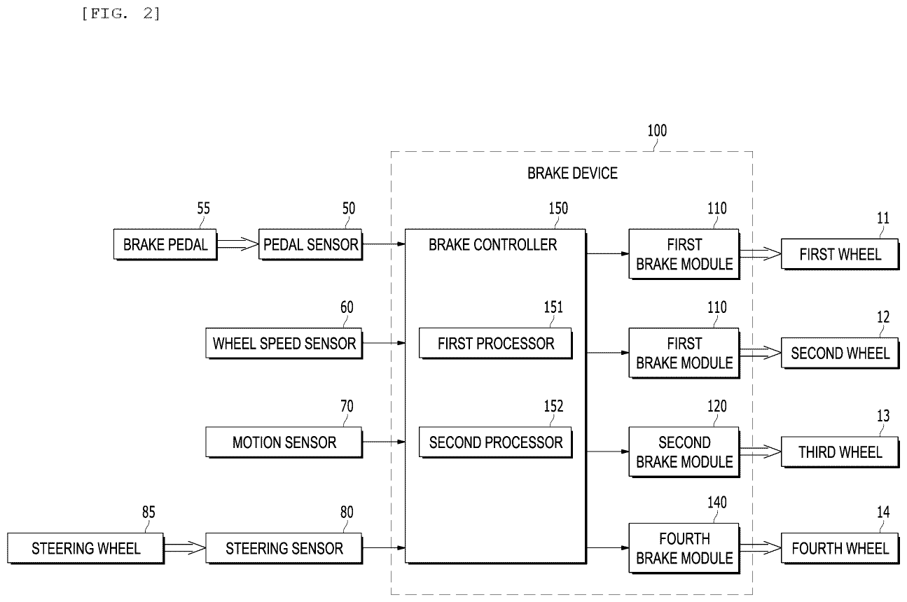

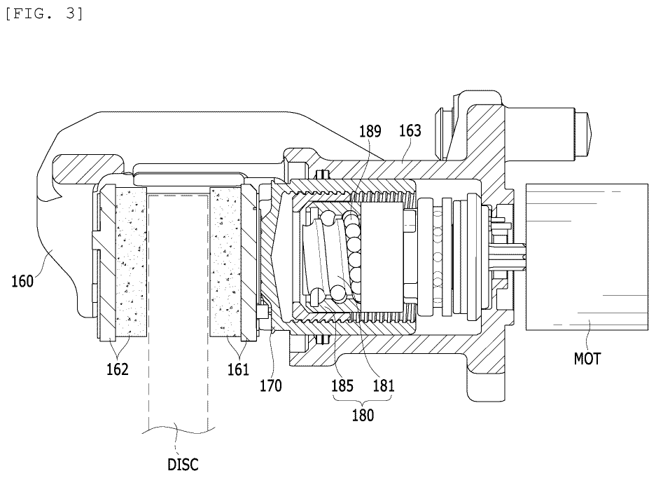

FIG. 2 illustrates configurations of an electromechanical brake device and a vehicle related thereto according to one embodiment of the present disclosure. FIG. 3 illustrates an example of the electromechanical brake according to one embodiment of the present disclosure. FIG. 4 illustrates an example of a connection relationship between components included in a brake device according to one embodiment of the present disclosure.

The vehicle 1 may include rotating wheels 11, 12, 13, and 14.

The wheels 11, 12, 13, and 14 may include, for example, a first wheel 11 provided on the front left side of the vehicle 1, a second wheel 12 provided on the front right side of the vehicle 1, a third wheel 13 provided on the rear left side of the vehicle 1, and/or a fourth wheel 14 provided on the rear right side of the vehicle 1. The number of wheels 11, 12, 13, and 14 is not limited to four.

As illustrated in FIG. 2, the vehicle 1 may include a brake pedal 55 for obtaining input related to driver's braking, a pedal sensor 50 for detecting movement of the brake pedal 55, a wheel speed sensor 60 for detecting rotational speeds of the wheels 11, 12, 13, and 14, a steering wheel 85 for obtaining input related to driver's steering, a motion sensor 70 for detecting movement of the vehicle 1, a steering sensor 80 for detecting rotation of the steering wheel 85, and the brake device 100 for providing braking force to the wheels 11, 12, 13, and 14 to stop the vehicle 1. The pedal sensor 50, the wheel speed sensor 60, the motion sensor 70, and the steering sensor 80 are not essential components, and all or at least some of them may be omitted.

The brake device 100 may include electromechanical brake modules 110, 120, 130, and 140 (hereinafter referred to as “brake”) installed on each wheel 11, 12, 13, and 14 and a brake controller 150 that controls each of the brake modules 110, 120, 130, and 140.

The brake modules 110, 120, 130, and 140 may brake the wheels 11, 12, 13, and 14 and the vehicle 1, respectively. For example, the brake modules 110, 120, 130, and 140 may include a first brake module 110 that breaks the first wheel 11, a second brake module 120 that brakes the second wheel 12, a third brake module 130 that brakes the third wheel 13, and/or a fourth brake module 140 that brakes the fourth wheel 14. The number of brake modules 110, 120, 130, and 140 is not limited to four.

Each of the brake modules 110, 120, 130, and 140 may operate solely based on a braking signal output from the brake controller 150 without being mechanically or fluidically connected to the brake pedal 55.

For example, as illustrated in FIG. 3, each of the brake modules 110, 120, 130, and 140 may include a caliper brake.

The caliper brake may include a pair of pad plates 161 and 162 installed to pressurize a brake disc DISC that rotates together with the wheels 11, 12, 13, and 14, a caliper housing 160 that operates the pair of pad plates 161 and 162, a piston 170 that is installed to be movable forward or backward inside the caliper housing 160, a power conversion unit 180 that receives a rotational driving force for moving the piston 170, converts the rotational driving force into a linear driving force, and transmits the linear driving force to the piston 170, and a brake motor MOT that generates a rotational driving force for moving the piston 170. The pad plates 161 and 162, the caliper housing 160, the piston 170, the power conversion unit 180, and the brake motor MOT are not essential components, and all or at least some of them may be omitted.

The piston 170 may be provided in a cup shape of which the rear side (right side of FIG. 3) is open, and is inserted to be slidable inside a cylinder portion 163. In addition, the piston 170 may receive power through the power conversion unit 180 to press the inner pad plate 161 toward the brake disc DISC.

The power conversion unit 180 may include a spindle 181 that receives driving force from the brake motor MOT and rotates, a nut 185 that is disposed inside the piston 170 and is screw-connected to the spindle 181 so as to move forward together with the piston 170 by a first direction rotation of the spindle 181 or move backward together with the piston 170 by a second direction rotation of the spindle 181, and a plurality of balls 189 interposed between the spindle 181 and the nut 185. The power conversion unit 180 may be provided as a ball-screw type conversion device that converts the rotational motion of the spindle 181 into linear motion.

The rotational motion of the brake motor MOT may be converted into the linear motion of the piston 170 by the power conversion unit 180. By the linear motion of the piston 170, the pair of pad plates 161 and 162 are pressed toward the brake disc DISC, and the wheels 11, 12, 13, and 14 may be braked by the friction between the pair of pad plates 161 and 162 and the brake disc DISC.

FIG. 3 illustrates the caliper brake as an example of the electromechanical brake, but the brake is not limited to the caliper brake. For example, the electromechanical brake may be a drum brake.

As illustrated in FIG. 4, the brake modules 110, 120, 130, and 140 may include brakes 111, 121, 131 and 141, brake motors 112, 122, 132 and 142, and motor controllers 113, 123, 133, and 143, respectively. The first brake module 110 includes a first brake 111, a first brake motor 112, and a first motor controller 113, and the first brake 111, the first brake motor 112, and the first motor controller 113 may be provided integrally. The second brake module 120 includes a second brake 121, a second brake motor 122, and a second motor controller 123, and the second brake 121, the second brake motor 122, and the second motor controller 123 may be provided integrally. The third brake module 130 includes a third brake 131, a third brake motor 132, and a third motor controller 133, and the third brake 131, the third brake motor 132, and the third motor controller 133 may be provided integrally. In addition, the fourth brake module 140 includes a fourth brake 141, a fourth brake motor 142, and a fourth motor controller 143, and the fourth brake 141, the fourth brake motor 142, and the fourth motor controller 143 may be provided integrally.

The brakes 111, 121, 131 and 141 may include paddle plates that brake the wheels 11, 12, 13, and 14 by contacting brake discs 11a, 12a, 13a, and 14a that rotate together with the wheels 11, 12, 13, and 14. The brakes 111, 121, 131 and 141 may include the first brake 111 associated with the first wheel 11, the second brake 121 associated with the second wheel 12, the third brake 131 associated with the third wheel 13, and the fourth brake 141 associated with the fourth wheel 14.

The brake motors 112, 122, 132 and 142 may provide torque to move the paddle plates so that the paddle plates come into contact with the brake discs 11a, 12a, 13a, and 14a. The rotation of each of the brake motors 112, 122, 132 and 142 is converted into linear movement through the spindle, and the linear movement of the piston may cause the paddle plates to come into contact with the brake discs 11a, 12a, 13a, and 14a. The brake motors 112, 122, 132 and 142 may include the first brake motor 112 associated with the first brake 111, the second brake motor 122 associated with the second brake 121, the third brake motor 132 associated with the third brake 131, and the fourth brake motor 142 associated with the fourth brake 141.

The motor controllers 113, 123, 133, and 143 may include the first motor controller 113 associated with the first brake motor 112, the second motor controller 123 associated with the second brake motor 122, the third motor controller 133 associated with the third brake motor 132, and the fourth motor controller 143 associated with the fourth brake motor 142.

The motor controllers 113, 123, 133, and 143 may control the driving current for rotating the brake motors 112, 122, 132 and 142 based on the braking signal of the brake controller 150. For example, each of the motor controllers 113, 123, 133, and 143 may include an H-bridge inverter or a three-phase inverter depending on the type of each of the brake motors 112, 122, 132 and 142. Additionally, each of the motor controllers 113, 123, 133, and 143 may include a drive processor that receives a braking signal from a first processor 151 or a second processor 152 and controls an H-bridge inverter or a three-phase inverter to control the driving current of the brake motors 112, 122, 132 and 142 based on the braking signal.

In this way, the motor controllers 113, 123, 133, and 143 may process the braking signal received from the brake controller 150 and control the driving current of the brake motors 112, 122, 132 and 142 based on the processing of the braking signal.

The brake controller 150 may receive output signals from the pedal sensor 50, the wheel speed sensor 60, the motion sensor 70, and/or the steering sensor 80, and control the operation of the brake modules 110, 120, 130, and 140.

The brake controller 150 may provide a braking signal to the brake modules 110, 120, 130, and 140 to brake the vehicle 1 based on the electrical signal output from the pedal sensor 50. For example, the brake controller 150 may identify a braking torque (or braking power or braking deacceleration or clamping force) for braking the vehicle 1 based on the output signal of the pedal sensor 50, and provide a braking signal corresponding to the identified braking torque (or braking force or braking deacceleration or clamping force) to the brake modules 110, 120, 130, and 140.

The brake controller 150 may distribute the braking force to the brake modules 110, 120, 130, and 140 to brake the vehicle 1 based on the electrical signal output from the pedal sensor 50. For example, the brake controller 150 may distribute a driver's required braking force to the brake modules 110, 120, 130, and 140 and provide the braking signal corresponding to the braking power distributed to each of the brake modules 110, 120, 130, and 140. In this way, the brake device 100 may include an electronic brake force distribution (EBD).

The brake controller 150 may provide the braking signal to the brake modules 110, 120, 130, and 140 to temporarily allow rotation of the wheels 11, 12, 13, and 14 based on the electrical signal output from the wheel speed sensor 60. For example, the brake controller 150 may identify slip of the wheels 11, 12, 13, and 14 based on the output signal of the wheel speed sensor 60 while braking the vehicle 1. The brake controller 150 may provide a braking signal to the brake modules 110, 120, 130, and 140 to temporarily allow rotation of the wheels 11, 12, 13, and 14 in response to slip of the wheels 11, 12, 13, and 14 to relieve the slip of the wheels 11, 12, 13, and 14. In this way, the brake device 100 may include an anti-lock braking system (ABS).

The brake controller 150 may provide the braking signal to the brake modules 110, 120, 130, and 140 to temporarily brake the wheels 11, 12, 13, and 14 without the user's braking intention to brake based on an electrical signal output from the wheel speed sensor 60. For example, the brake controller 150 may identify the spin of the wheels 11, 12, 13, and 14 based on the output signal of the wheel speed sensor 60 while the vehicle 1 is traveling. The brake controller 150 may provide a braking signal to the brake modules 110, 120, 130, and 140 to temporarily brake the wheels 11, 12, 13, and 14 in response to the spin of the wheels 11, 12, 13, and 14 to relieve the spin of the wheels 11, 12, 13, and 14. In this way, the brake device 100 may include a traction control system (TCS).

The brake controller 150 may provide a braking signal to the brake modules 110, 120, 130, and 140 to temporarily brake the wheels 11, 12, 13, and 14 without the user's braking intention based on the electrical signal output from the motion sensor 70 and/or the steering sensor 80. For example, the brake controller 150 may identify a reference path (reference turning traveling path) of the vehicle 1 based on an output signal of the steering sensor 80 during steering of the vehicle 1, and may identify a traveling path (turning traveling path) of the vehicle 1 based on an output signal of the motion sensor 70 during steering of the vehicle 1. The brake controller 150 may identify oversteering or understeering of the vehicle 1 based on the reference path and the traveling path. The brake controller 150 may provide a braking signal to the brake modules 110, 120, 130, and 140 to temporarily brake the wheels 11, 12, 13, and 14 based on oversteering and/or understeering. As such, the brake device 100 may include an electronic stability control (ESC).

The brake controller 150 may provide a parking signal to the brake modules 110, 120, 130, and 140 to prevent rotation of the wheels 11, 12, 13, and 14 in response to a driver's parking command. As such, the brake device 100 may include an electronic parking brake (EPB).

The brake controller 150 may include processors 151 and 152 that processes output signals of the pedal sensor 50, the wheel speed sensor 60, the motion sensor 70, and/or the steering sensor 80 and outputs electrical signals corresponding to a service brake, EBD, ABS, TSC, ESC, EPB, or the like to brake modules 110, 120, 130, and 140.

The brake controller 150 may include a plurality of processors 151 and 152 to prepare for damage or errors in the electrical system. For example, the brake controller 150 may include a first processor 151 and, as a reserve, a second processor 152. The second processor 152 is not an essential component and may be omitted.

The first processor 151 may be provided separately from the brake modules 110, 120, 130, and 140 or may be provided integrally with one of the brake modules 110, 120, 130, and 140.

The first processor 151 may control all of the brake modules 110, 120, 130, and 140 or may control only some of the brake modules 110, 120, 130, and 140. For example, the first processor 151 provided integrally with the first brake module 110 may control all of the brake modules 110, 120, 130, and 140 during a normal operation.

The first processor 151 may process output signals of the pedal sensor 50, the wheel speed sensor 60, the motion sensor 70, and/or the steering sensor 80. The first processor 151 may identify a braking torque (or braking force, braking deacceleration, or clamping force) corresponding to the service brake, EBD, ABS, TSC, ESC, EPB, or the like based on the processing of the output signals, and output a braking signal corresponding to the braking torque to all or some of the brake modules 110, 120, 130, and 140. The brake modules 110, 120, 130, and 140 that receive the braking signal may brake the wheels 11, 12, 13, and 14 according to the braking force corresponding to the braking signal.

The first processor 151 may receive a first pedal signal PTS1 from first pedal sensor 51 and first, second, third, and fourth wheel speed signals WSS1 to WSS4 from first, second, third, and fourth wheel speed sensors 41, 42, 43, and 44. In addition, the first processor 151 may be connected to the vehicle communication network NT. For example, the first processor 151 may receive a yaw rate signal representing a yaw rate of the vehicle 1 from the motion sensor 70 and a steering angle signal representing a steering angle of the vehicle 1 from the steering sensor 80 through the vehicle communication network NT.

The first processor 151 may be connected to the first, second, third, and fourth motor controllers 113, 123, 133, and 143 through a first communication network CAN1 and may communicate with the motor controllers 113, 123, 133, and 143. In addition, the first processor 151 may also be connected to the first, second, third, and fourth motor controllers 113, 123, 133, and 143 through the first communication network CAN1.

The first communication network CAN1 may be, for example, a dedicated communication network separate and independent from the vehicle communication network NT. Since the first communication network CAN1 is separate and independent from the vehicle communication network NT, the braking signal by the first processor 151 may be transmitted to the first, second, third, and fourth brake modules 110, 120, 130, and 140 more quickly, and the first, second, third, and fourth brake modules 110, 120, 130, and 140 may brake the wheels 11, 12, 13, and 14 more quickly. The first communication network CAN1 may use various communication methods such as Ethernet, media oriented systems transport (MOST), Flexray, a controller area network (CAN), and a local interconnect network (LIN).

The first processor 151 may provide a braking signal representing a braking torque (or braking force, braking deacceleration, or clamping force) to each of the first, second, third, and fourth brake modules 110, 120, 130, and 140. For example, the first processor 151 may identify a driver's required braking torque based on the first pedal signal PTS1 and distribute the driver's required braking torque to the first, second, third, and fourth brake modules 110, 120, 130, and 140.

The first processor 151 may identify slip and/or spin of the first, second, third and fourth wheel 11, 12, 13, and 14 based on the first, second, third, and fourth wheel speed signals WSS1 to WSS4, and control the first, second, third, and fourth brake modules 110, 120, 130, and 140 based on the slip and/or spin of the first, second, third and fourth wheel 11, 12, 13, and 14.

The first processor 151 may transmit a parking signal to each of the third and fourth brake modules 130 and 140 to engage or release the parking brake based on the driver's parking command.

In this way, the first processor 151 may provide control signals for EBD, ABS, TSC, ESC, and EPB to each of the first, second, third, and fourth brake modules 110, 120, 130, and 140.

The first processor 151 may communicate with the second processor 152. For example, the first processor 151 may periodically transmit an electrical signal to the second processor 152. The second processor 152 may identify an operating state (for example, a normal state or a failure state) of the first processor 151 based on whether the first processor 151 receives a periodic status signal. In addition, the first processor 151 may periodically receive an electrical signal from the second processor 152. The first processor 151 may identify the normal state of the second processor 152 based on receiving the periodic status signal from the second processor 152, and may identify the failure state (for example, damage or error or reset or power cut, or the like) of the second processor 152 based on the second processor 152 stopping receiving the periodic status signal.

The second processor 152 may be provided separately from the brake modules 110, 120, 130, and 140 or integrally with another brake module among the brake modules 110, 120, 130, and 140.

The second processor 152 may control all of the brake modules 110, 120, 130, and 140 or may control only some of the brake modules 110, 120, 130, and 140. For example, the second processor 152 provided integrally with the second brake module 120 may control all of the brake modules 110, 120, 130, and 140 during a failure of the first processor 151.

The second processor 152 may process the output signals of the pedal sensor 50, the wheel speed sensor 60, the motion sensor 70, and/or the steering sensor 80, and based on processing the output signals, may identify the braking power corresponding to the service brake, EBD, ABS, TSC, ESC, EPB, or the like, and output the braking signal corresponding to the braking power to all or some of the brake modules 110, 120, 130, and 140. The brake modules 110, 120, 130, and 140 that receive the braking signal may brake the wheels 11, 12, 13, and 14 according to the braking power corresponding to the braking signal.

The second processor 152 may receive a second pedal signal PTS2 from the second pedal sensor 52 and wheel speed signals WSS1 to WSS4 from the wheel speed sensors 41, 42, 43, and 44. In addition, the second processor 152 may be connected to the vehicle communication network NT independently from the first processor 151. For example, the second processor 152 may receive the yaw rate signal indicating the yaw rate of the vehicle 1 from the motion sensor 70 and the steering angle signal indicating the steering angle of the vehicle 1 from the steering sensor 80 through the vehicle communication network NT.

The second processor 152 may be connected to the motor controllers 113, 123, 133, and 143 through the second communication network CAN2 and may communicate with the motor controllers 113, 123, 133, and 143 through the second communication network CAN2. The second communication network CAN2 may be, for example, a dedicated communication network separate and independent from the vehicle communication network NT and the first communication network CAN1. The second communication network CAN2 may use various communication methods such as Ethernet, MOST, FlexRay, CAN, and LIN. In addition, the second processor 152 may also be connected to the first, second, third, and fourth motor controllers 113, 123, 133, and 143 through the second communication network CAN2.

The second communication network CAN2 may be a dedicated communication network that is, for example, separate and independent from the vehicle communication network NT and the first communication network CAN1. Since the second communication network CAN2 is separate and independent from the vehicle communication network NT and the first communication network CAN1, the braking signal by the second processor 152 may be transmitted to the motor controllers 113, 123, 133, and 143 more quickly, and the brake modules 110, 120, 130, and 140 may brake the wheels 11, 12, 13, and 14 more quickly. The second communication network CAN2 may use various communication methods such as Ethernet, MOST, FlexRay, CAN, and LIN.

The second processor 152 may provide the braking signal representing the braking torque (or braking force, braking deacceleration, or clamping force) to each of the first, second, third, and fourth brake modules 110, 120, 130, and 140. For example, the second processor 152 may identify the driver's required braking torque based on the second pedal signal PTS2 and distribute the driver's required braking torque to the first, second, third, and fourth brake modules 110, 120, 130, and 140.

The second processor 152 may identify slip and/or spin of the first, second, third or fourth wheel 11, 12, 13, or 14 based on the first, second, third, and fourth wheel speed signals WSS1 to WSS4, and control the first, second, third, and fourth brake modules 110, 120, 130, and 140 based on the slip and/or spin of the first, second, third or fourth wheel 11, 12, 13, or 14.

The second processor 152 may transmit the parking signal to each of the third and fourth brake modules 130 and 140 to engage or release the parking brake based on the driver's parking command.

In this way, the second processor 152 may provide the control signals for EBD, ABS, TSC, ESC, and EPB to each of the first, second, third, and fourth brake modules 110, 120, 130, and 140.

The second processor 152 may communicate with the first processor 151. For example, the second processor 152 may periodically transmit an electrical signal to the first processor 151. The first processor 151 may identify an operating state (for example, a normal state or a failure state) of the second processor 152 based on whether the second processor 152 receives the periodic status signal. In addition, the second processor 152 may periodically receive an electrical signal from the first processor 151. The second processor 152 may identify the normal state of the first processor 151 based on the first processor 151 receiving the periodic status signal and may identify the failure state of the first processor 151 based on the first processor 151 stopping receiving the periodic status signal.

The second processor 152 may be implemented with semiconductor devices provided separately from the first processor 151. Alternatively, the second processor 152 may be implemented with processing cores provided in a separate area within a single semiconductor device from the first processor 151.

The second processor 152 may have the same or less computational power as the first processor 151. For example, the number of instructions that the second processor 152 may process per unit time may be the same or less than the number of instructions that the first processor 151 may process per unit time.

In this way, the brake controller 150 may include the first processor 151 and the second processor 152. Accordingly, when the first processor 151 fails, the second processor 152 may control the brake modules 110, 120, 130, and 140, and when the second processor 152 fails, the first processor 151 may control the brake modules 110, 120, 130, and 140.

The brake pedal 55 may be provided at the lower portion of a cabin so that the driver may control the pedal brake with his/her foot, for example. The driver may step on the brake pedal 55 as a braking intention to brake the vehicle 1. Depending on the driver's braking intention, the brake pedal 55 may move away from the reference position.

The pedal sensor 50 may be installed near the brake pedal 55 and may measure the movement of the brake pedal 55 due to the driver's braking intention. For example, the pedal sensor 50 may detect the movement distance and/or movement speed from the reference position of the brake pedal 55.

The pedal sensor 50 may be electrically connected to the brake device 100 and may provide an electrical signal to the brake device 100. For example, the pedal sensor 50 may be directly connected to the brake device 100 via a hard wire or may be connected to the brake device 100 via a communication network. The pedal sensor 50 may provide an electrical signal corresponding to a movement distance and/or a movement speed of the brake pedal 55 to the brake device 100. In addition, the pedal sensor 50 may be provided integrally with the brake device 100.

The pedal sensor 50 may include a plurality of pedal sensors to protect against damage or errors in the electrical system. For example, the pedal sensor 50 may include a first sensor and a second sensor. The first sensor and the second sensor may provide the electrical signal corresponding to the movement distance and/or the movement speed of the brake pedal 55 to the brake device 100, respectively.

As illustrated in FIG. 4, the pedal sensor 50 may include the first pedal sensor 51 and the second pedal sensor 52. The first pedal sensor 51 and the second pedal sensor 52 may each detect movement of the brake pedal 55 and provide the electrical output signals PTS1 and PTS2 corresponding to the movement (for example, movement displacement and/or movement speed) of the brake pedal 55 to the first processor 151 and the second processor 152, respectively. For example, the first pedal sensor 51 may be electrically connected to the first processor 151 and provide the first pedal signal PTS1 to the first processor 151. The second pedal sensor 52 may be electrically connected to the second processor 152 and provide the second pedal signal PTS2 to the second processor 152.

The wheel speed sensor 60 may include a plurality of wheel speed sensors each installed on the wheels 11, 12, 13, and 14. The plurality of wheel speed sensors may independently detect the rotational speeds of the wheels 11, 12, 13, and 14.

The wheel speed sensor 60 may be electrically connected to the brake device 100 and may provide the electrical signal to the brake device 100. For example, each of the plurality of wheel speed sensors may be directly connected to the brake device 100 via a hard wire or connected to the brake device 100 via a communication network. Each of the plurality of wheel speed sensors may provide the electrical signals corresponding to the rotational speeds of the wheels 11, 12, 13, and 14 to the brake device 100.

Each of the plurality of wheel speed sensors installed on each of the wheels 11, 12, 13, and 14 may include the plurality of sensors to protect against damage or errors in the electrical system. For example, each of the plurality of wheel speed sensors may include a first sensor and a second sensor. Each of the first sensor and the second sensor may provide the electrical signal corresponding to the rotational speed of one of the wheels 11, 12, 13, and 14 to the brake device 100.

As illustrated in FIG. 4, the wheel speed sensor 60 may include a first wheel speed sensor 61, a second wheel speed sensor 62, a third wheel speed sensor 63, and a fourth wheel speed sensor 64. The wheel speed sensors 41, 42, 43, and 44 may provide the electrical output signals WSS1, WSS2, WSS3, and WSS4 corresponding to the rotational speeds of the wheels 11, 12, 13, and 14 to the first processor 151 and the second processor 152, respectively.

For example, the first wheel speed sensor 61 may provide the first wheel speed signal WSS1 corresponding to the rotational speed of the first wheel 11 to the first processor 151 and the second processor 152, and the second wheel speed sensor 62 may provide the second wheel speed signal WSS2 corresponding to the rotational speed of the second wheel 12 to the first processor 151 and the second processor 152. The third wheel speed sensor 63 may provide the third wheel speed signal WSS3 corresponding to the rotational speed of the third wheel 13 to the first processor 151 and the second processor 152, and the fourth wheel speed sensor 64 may provide the fourth wheel speed signal WSS4 corresponding to the rotational speed of the fourth wheel 14 to the first processor 151 and the second processor 152. In other words, the first processor 151 and the second processor 152 may obtain the wheel speed signals WSS1 to WSS4 from the first, second, third, and fourth wheel speed sensors 41, 42, 43, and 44, respectively.

The motion sensor 70 may be installed approximately at the center of the vehicle 1 and may include an acceleration sensor and a gyro sensor capable of detecting linear movement and rotational movement of the vehicle 1. The acceleration sensor may detect linear movement of the vehicle 1 and the motion sensor 70. For example, the acceleration sensor may measure the acceleration, speed, movement displacement, and movement direction of the vehicle 1 while the vehicle 1 moves linearly. The gyro sensor may detect rotational movement of the vehicle 1 and the motion sensor 70. For example, the gyro sensor may measure the angular acceleration, angular velocity, and/or rotational displacement of the vehicle 1 while the vehicle 1 moves rotationally.

The motion sensor 70 may detect the yaw rate, which indicates the rotation of the vehicle 1 around an axis perpendicular to the ground on which the vehicle 1 is traveling.

The motion sensor 70 may be electrically connected to the brake device 100 and may provide the electrical signals representing linear and rotational movements of the vehicle 1 to the brake device 100. The motion sensor 70 may be directly connected to the brake device 100 via a hard wire or connected to the brake device 100 via a communication network. The motion sensor 70 may provide the electrical signal corresponding to the yaw rate of the vehicle 1 to the brake device 100.

The steering wheel 85 may be provided in front of the driver's seat, for example, so that the driver may control the steering wheel with his/her hands. The driver may turn the steering wheel 85 as the steering intention to steer the vehicle 1. According to the driver's steering intention, the steering wheel 85 may be turned clockwise or counterclockwise.

The steering sensor 80 may be installed near a column connected to the steering wheel 85 and may measure the rotation of the steering wheel 85 by the driver's steering intention. For example, the steering sensor 80 may detect the angle by which the steering wheel 85 is rotated from the reference rotation position.

The steering sensor 80 may be electrically connected to the brake device 100 and may provide the electrical signal to the brake device 100. For example, the steering sensor 80 may be directly connected to the brake device 100 via a hard wire or may be connected to the brake device 100 via a communication network. Additionally, the steering sensor 80 may provide the electrical signal corresponding to the rotation angle and/or torque of the steering wheel 85 to the brake device 100.

In this way, the brake device 100 includes the brake modules 110, 120, 130, and 140 and the brake controller 150, and each of the brake modules 110, 120, 130, and 140 may operate only based on a braking signal output from the brake controller 150 without being mechanically or fluidically connected to the brake pedal 55.

In this way, since there is no mechanical or fluidic connection between the brake pedal 55 and the brake modules 110, 120, 130, and 140, a configuration is provided to respond to the failures of the brake modules 110, 120, 130, and 140 or the failures of the brake controller 150 to ensure stability.

For example, the brake controller 150 may not only include the first processor 151, but may also include the second processor 152 to prepare for the failure of the first processor 151.

Additionally, a response strategy may be prepared to deal with the failures of the brake modules 110, 120, 130, and 140.

Various failures may occur in the brake modules 110, 120, 130, and 140. For example, failures may occur in the brakes 111, 121, 131 and 141. Mechanical failures, such as damage to the pad plates, caliper housings, pistons, cylinders, spindles, or nuts included in each of the brakes 111, 121, 131 and 141, may occur. Electrical failures, such as open circuits or short circuits in windings, or mechanical failures, such as damage to bearings, may occur in the brake motors 112, 122, 132 and 142. The electrical failures, such as damage, short circuits, or open circuits in switching elements, may occur in the motor controllers 113, 123, 133, and 143. Additionally, the electrical failure, such as a power failure in the brake modules 110, 120, 130, and 140, may occur.

At least one of the brake modules 110, 120, 130, and 140 may fail. For example, the first brake module 110 associated with the first wheel 11 may fail, or a second brake module 120 associated with a second wheel 12 may fail, or a third brake module 130 associated with a third wheel 13 may fail, or a fourth brake module 140 associated with a fourth wheel 14 may fail.

The brake device 100 may cooperate with the driving device 20 to provide braking torque required by the driver when a failure occurs in at least one of the brake modules 110, 120, 130, and 140. For example, the brake device 100 may request the driving device 20 to perform regenerative braking to compensate for a lack of braking torque due to a failure in at least one of the brake modules 110, 120, 130, and 140.

The brake device 100 may cooperate with the steering device 40 to secure the driving stability of the vehicle 1 when a failure occurs in at least one of the brake modules 110, 120, 130, and 140. For example, the brake device 100 may request the steering device 40 to steer the vehicle 1 to compensate for biased braking due to a failure in at least one of the brake modules 110, 120, 130, and 140.

Hereinafter, the cooperation between the brake device 100 and the driving device 20 or the cooperation between the brake device 100 and the steering device 40 due to a failure in at least one of the brake modules 110, 120, 130, and 140 is described.

The brake device 100 may identify the failures of the brake modules 110, 120, 130, and 140 through various means.

For example, the brake controller 150 may identify the failures of the brake modules 110, 120, 130, and 140 based on the communication signals of the motor controllers 113, 123, 133, and 143. The motor controllers 113, 123, 133, and 143 may each include a position sensor for detecting the rotation of the brake motors 112, 122, 132 and 142 and a current sensor for detecting the driving current of the brake motors 112, 122, 132 and 142. The motor controllers 113, 123, 133, and 143 may identify a failure of at least one of the brakes 111, 121, 131 and 141, the brake motors 112, 122, 132 and 142, and the motor controllers 113, 123, 133, and 143 based on the output of the position sensor and/or the output of the current sensor, respectively. The motor controllers 113, 123, 133, and 143 may each transmit information on the failure of the brake module to the brake controller 150 in response to a failure of at least one of the brakes 111, 121, 131 and 141, the brake motors 112, 122, 132 and 142, and the motor controllers 113, 123, 133, and 143.

As another example, the brake controller 150 may identify the failures of the brake modules 110, 120, 130, and 140 based on the response signals of the motor controllers 113, 123, 133, and 143. The brake controller 150 may request a response from each of the motor controllers 113, 123, 133, and 143 and identify the failure of each of the motor controllers 113, 123, 133, and 143 based on whether or not the response signal from each of the motor controllers 113, 123, 133, and 143 is received.

As another example, the brake controller 150 may transmit the braking signal to each of the brake modules 110, 120, 130, and 140 and identify the failures of the brake modules 110, 120, 130, and 140 based on the output signal of the wheel speed sensor 60.

The brake device 100 may cooperate with the driving device 20 in response to the failure of any one of the brake modules 110, 120, 130, and 140. For example, the brake device 100 may request regenerative braking from the driving device 20 or request the steering to supplement the biased braking from the steering device 40 in response to the failure of any one of the brake modules 110, 120, 130, and 140.

For example, the brake controller 150 may identify the individual required braking torque (or required braking force, required deceleration, or required clamping force) of each wheel or the total required braking torque of the driver (for example, the sum of the individual required braking torques required for each wheel) based on the output signal of the pedal sensor 50. The brake controller 150 may obtain the maximum regenerative braking torque of the driving motor for cooperation with the driving device 20. The maximum regenerative braking torque may vary depending on, for example, the traveling speed of the vehicle 1.

The brake controller 150 may compare the driver's required braking torque (total required braking torque or individual required braking torque) with the maximum regenerative braking torque of the driving device 20, and based on the comparison result, request the regenerative braking from the driving device 20 and distribute the required braking torque to the brake modules 110, 120, 130, and 140 without failure.

When the driver's required braking torque is less than or equal to the maximum regenerative braking torque of the driving motor, the brake controller 150 may request the regenerative braking of the driving motor from the driving device 20 to generate the individual required braking torque required for the brake module with failure. Moreover, the brake controller 150 may provide a braking signal to the brake module without failure to generate the individual required braking torque.

When the driver's required braking torque is less than or equal to the maximum regenerative braking torque of the driving motor, the brake controller 150 may request the regenerative braking of the driving motor from the driving device 20 to generate the sum of the individual required braking torques required for the brake module with failure and the brake module of the same axle. Moreover, the brake controller 150 may provide the braking signal to the brake module having the axle different from the axle of the brake module with failure to generate the individual required braking torques.

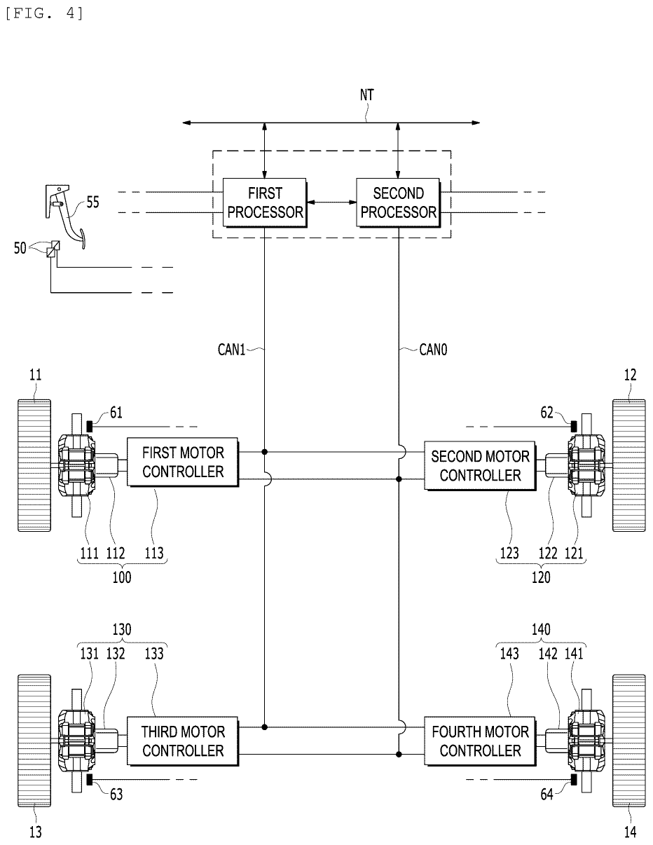

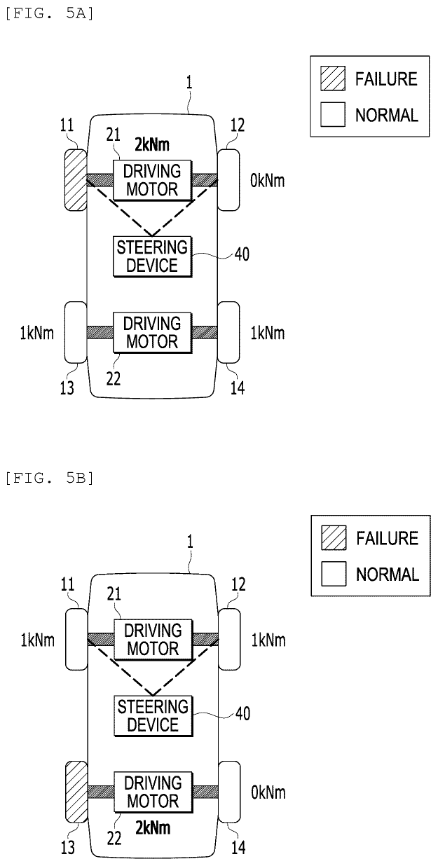

FIGS. 5A and 5B illustrate an example of a brake device according to one embodiment of the present disclosure cooperating with the driving device in response to the failure of any one brake module.

As illustrated in FIGS. 5A and 5B, the driving device 20 may include a first driving motor 21 that drives the first and second wheels 11 and 12 and a second driving motor 22 that drives the third and fourth wheels 13 and 14.

Any one of the brake modules 110 and 120 associated with the front wheels 11 and 12 may fail, or any one of the brake modules 130, and 140 associated with the rear wheels 13, and 14 may fail. The failures of the brake modules 110, 120, 130, and 140 may include the failures of the brakes 111, 121, 131 and 141, the failures of the brake motors 112, 122, 132 and 142, and/or the failures of the motor controllers 113, 123, 133, and 143.

The brake controller 150 may identify the driver's individual required braking torque or the total required braking torque based on the output signal of the pedal sensor 50. The brake controller 150 may obtain the maximum regenerative braking torque of the driving device 20 (the sum of the maximum regenerative braking torque of the first driving motor and the maximum regenerative braking torque of the second driving motor).

In response to the total required braking torque being less than or equal to the maximum regenerative braking torque of the driving device 20 and any one of the brake modules failing, the brake controller 150 may transmit the regenerative braking signal to the driving device 20 so that the driving motor of the axle having the failed brake module generates the regenerative braking torque corresponding to the required braking torque of the axle having failed brake module, and transmit the braking signals corresponding to the individual required braking torques to the brake modules without failure.

As illustrated in FIG. 5A, the failure of the first brake module 110 associated with the front first wheel 11 may be identified. For example, when the total required braking torque of the driver is 4 kNm (or the individual required braking torque is 1 kNm) and the maximum regenerative braking torque of the driving device 20 is 4 kNm, the brake controller 150 may request the regenerative braking of the first driving motor 21 from the driving device 20 to generate braking torque of 2 kNm, which is the required braking torque of the first and second wheels 11 and 12. In addition, the brake controller 150 may transmit the braking signal to each of the third and fourth brake modules 130 and 140 to generate braking torque of 1 kNm, which is the required braking torque of each of the third and fourth wheels 13 and 14.

Accordingly, the brake device 100 may compensate for the lack of braking torque due to the failure of the brake module, and also prevent biased braking due to the failure of the brake module.

As illustrated in FIG. 5B, the failure of the third brake module 130 associated with the rear third wheel 13 may be identified. When the total required braking torque of the driver is 4 kNm (or the individual required braking torque is 1 kNm) and the maximum regenerative braking torque of the driving device 20 is 4 kNm, the brake controller 150 may request the regenerative braking of the second driving motor 22 from the driving device 20 to generate the braking torque of 2 kNm, which is the required braking torque of the third and fourth wheels 13 and 14. In addition, the brake controller 150 may transmit the braking signal to each of the first and second brake modules 110 and 120 to generate the braking torque of 1 kNm, which is the required braking torque of each of the first and second wheels 11 and 12.

Accordingly, the brake device 100 may compensate for the lack of the braking torque due to the failure of the brake module, and also prevent the biased braking due to the failure of the brake module.

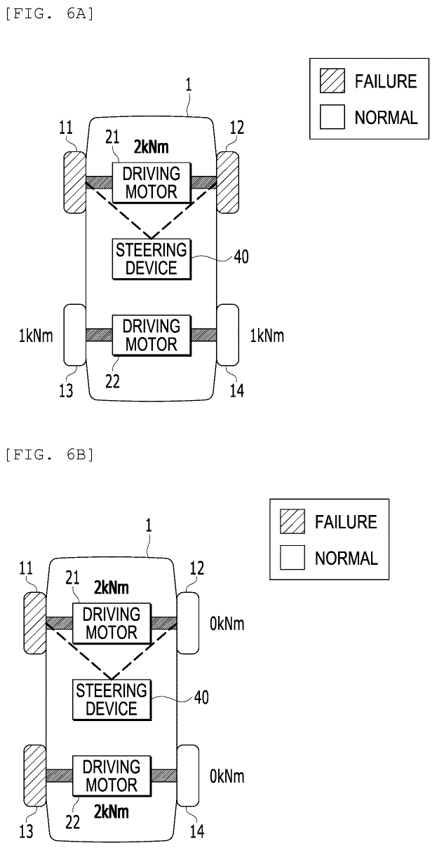

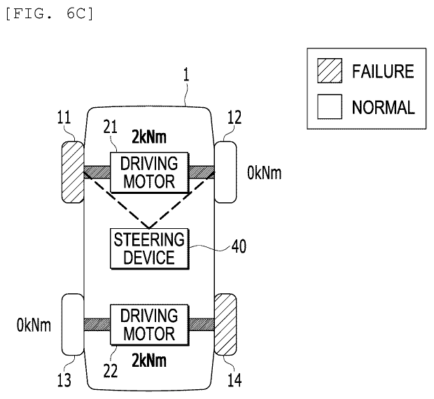

FIGS. 6A, 6B, and 6C illustrate an example of the brake device according to one embodiment of the present disclosure cooperating with the driving device and the steering device in response to the failures of any two brake modules.

As illustrated in FIGS. 6A, 6B, and 6C, the driving device 20 may include the first driving motor 21 that drives the first and second wheels 11 and 12 and the second driving motor 22 that drives the third and fourth wheels 13 and 14.

The brake modules (the first brake module and the second brake module, the third brake module and the fourth brake module) located on the same axle may fail, or the brake modules (the first brake module and the third brake module, the second brake module and the fourth brake module) located on the same side of different axles may fail. Alternatively, the brake modules located on different sides of different axles (the first brake module and the fourth brake module, the second brake module and the third brake module) may fail.

In response to the total required braking torque being less than or equal to the maximum regenerative braking torque of the driving device 20 and the brake modules located on the same axle failing, the brake controller 150 may transmit the regenerative braking signal to the driving device 20 so that the driving motor of the axle having the failed brake module generates the regenerative braking torque corresponding to the required braking torque of the axle having the failed brake module and transmit the braking signal corresponding to the individual required braking torque to the brake modules without failure.

As illustrated in FIG. 6A, the brake controller 150 may identify the failures of the first and second brake modules 110 and 120 associated with the front first and second wheels 11 and 12. For example, when the total required braking torque of the driver is 4 kNm (or the individual required braking torque is 1 kNm) and the maximum regenerative braking torque of the driving device 20 is 4 kNm, the brake controller 150 may request the regenerative braking of the first driving motor 21 from the driving device 20 to generate the braking torque of 2 kNm, which is the required braking torque of the first and second wheels 11 and 12. Moreover, the brake controller 150 may transmit the braking signal to each of the third and fourth brake modules 130 and 140 to generate the braking torque of 1 kNm, which is the required braking torque of each of the third and fourth wheels 13 and 14.

Accordingly, the brake device 100 may compensate for the lack of the braking torque due to the failure of the brake module.

In response to the total required braking torque being less than or equal to the maximum regenerative braking torque of the driving device 20 and the brake modules located on the same side of the different axles failing, the brake controller 150 may transmit the regenerative braking signal to the driving device 20 so that the driving motor of the axle having the failed brake module generates the regenerative braking torque corresponding to the required braking torque of the axle having the failed brake module.

As illustrated in FIG. 6B, the brake controller 150 may identify the failures of the first brake module 110 associated with the front first wheel 11 and the third brake module 130 associated with the rear third wheel 13. For example, when the total required braking torque of the driver is 4 kNm (or the individual required braking torque is 1 kNm) and the maximum regenerative braking torque of the driving device 20 is 4 kNm, the brake controller 150 may request the regenerative braking of the first and second driving motors 21 and 22 from the driving device 20 to generate the braking torque of 2 kNm, which is the required braking torque of the first and second wheels 11 and 12, and to generate the braking torque of 2 kNm, which is the required braking torque of the third and fourth wheels 13 and 14.

Accordingly, the brake device 100 may compensate for the lack of the braking torque due to the failure of the brake module, and also prevent the biased braking due to the failure of the brake module in the same direction of different axles.

In response to the total required braking torque being less than or equal to the maximum regenerative braking torque of the driving device 20 and the brake modules located on different sides of different axles failing, the brake controller 150 may transmit the braking signal corresponding to the individual required braking torque to the brake modules without failure.

As illustrated in FIG. 6C, the brake controller 150 may identify the failures of the first brake module 110 associated with the front first wheel 11 and the fourth brake module 140 associated with the rear fourth wheel 14. For example, when the total required braking torque of the driver is 4 kNm (or the individual required braking torque is 1 kNm), the brake controller 150 may transmit the braking signal to the second brake module 120 to generate the braking torque of 2 kNm, which is the required braking torque of the first and second wheels 11 and 12, and may transmit the braking signal to the third brake module 130 to generate the braking torque of 2 kNm, which is the required braking torque of the third and fourth wheels 13 and 14.

Accordingly, the brake device 100 may compensate for the lack of the braking torque due to the failure of the brake module.

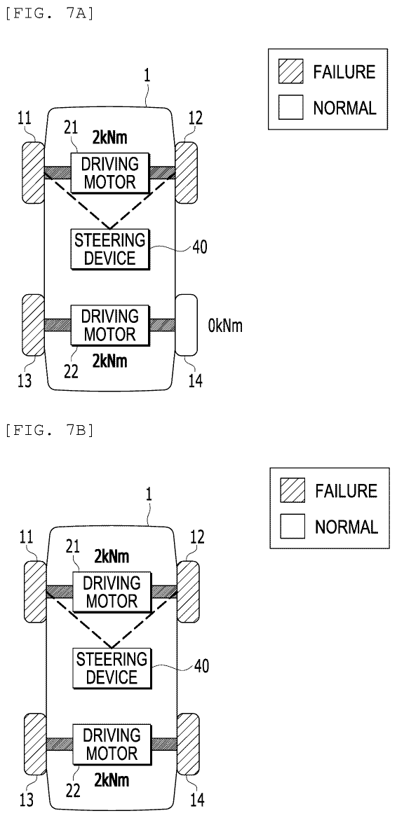

FIGS. 7A and 7B illustrate an example of the brake device according to one embodiment of the present disclosure cooperating with the driving device and the steering device in response to the failures of three or more brake modules.

As illustrated in FIGS. 7A and 7B, the driving device 20 may include the first driving motor 21 that drives the first and second wheels 11 and 12 and the second driving motor 22 that drives the third and fourth wheels 13 and 14.

Either three brake modules associated with three wheels may fail, or all brake modules associated with all wheels may fail.

In response to the total required braking torque being less than or equal to the maximum regenerative braking torque of the driving device 20 and three or more brake modules failing, the brake controller 150 may transmit the regenerative braking signal to the driving device 20 so that the driving motor of the axle having the failed brake module generates the regenerative braking torque corresponding to the required braking torque of the axle having the failed brake module.

As illustrated in FIG. 7A, the brake controller 150 may identify the failures of the first, second, and third brake modules 110, 120, and 130 associated with the first, second, and third wheels 11, 12, and 13. For example, when the total required braking torque is 4 kNm (or the individual required braking torque is 1 kNm) and the maximum regenerative braking torque of the driving device 20 is 4 kNm, the brake controller 150 may request the regenerative braking of the first and second driving motors 21 and 22 from the driving device 20 to generate the braking torque of 2 kNm, which is the required braking torque of the first and second wheels 11 and 12, and the braking torque of 2 kNm, which is the required braking torque of the third and fourth wheels 13 and 14.

Accordingly, the brake device 100 may compensate for the lack of the braking torque due to the failure of the brake module, and also prevent the biased braking due to the failure of the brake module in the same direction of different axles.

As illustrated in FIG. 7B, the brake controller 150 may identify the failures of all brake modules 110, 120, 130, and 140 associated with all wheels 11, 12, 13, and 14. The brake controller 150 may request the regenerative braking of all driving motors 21 and 22 from the driving device 20 to generate the required braking torques of all wheels 11, 12, 13, and 14.

Accordingly, the brake device 100 may provide the braking torque reduced by the failure of the brake module.

When the driver's required braking torque exceeds the maximum regenerative braking torque of the driving motor, the brake controller 150 may request the regenerative braking of the driving motor to generate the maximum regenerative braking torque. The brake controller 150 may provide the braking signal to brake module without failure to generate individual required braking torque to compensate for the lack of required braking torque. In addition, the brake controller 150 may request steering from the steering device 40 to compensate for the biased braking due to the lack of required braking torque.

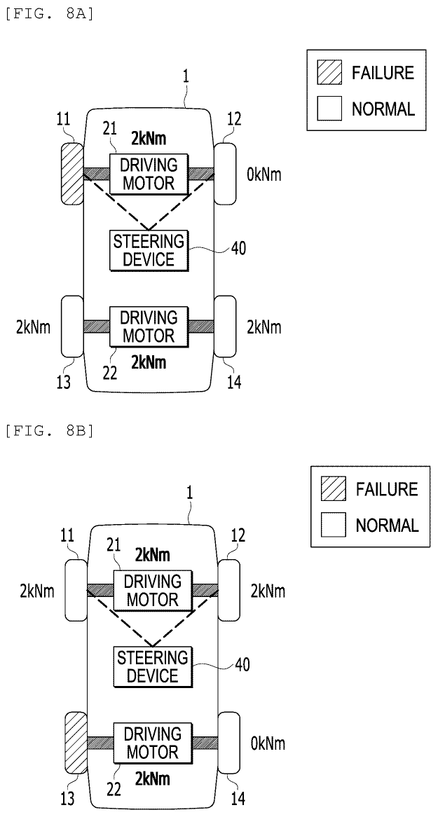

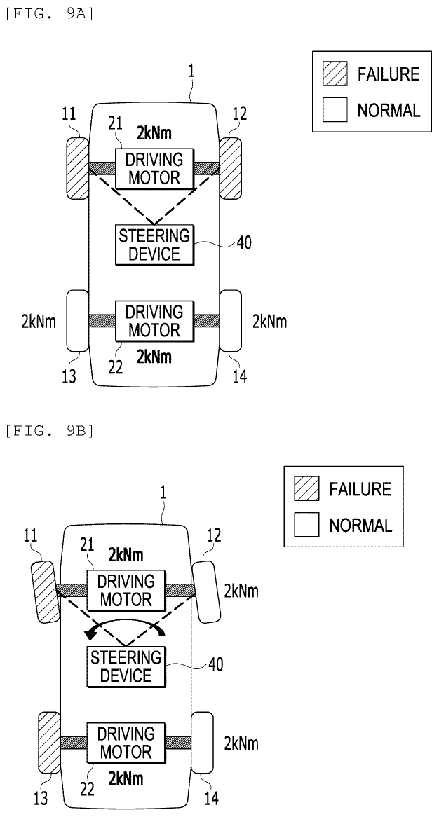

FIGS. 8A and 8B illustrate an example of the brake device according to one embodiment of the present disclosure cooperating with the driving device in response to the failure of any one brake module.

As illustrated in FIGS. 8A and 8B, the vehicle 1 may include the driving device 20 and the steering device 40. The driving device 20 may include the first driving motor 21 that drives the first and second wheels 11 and 12 and the second driving motor 22 that drives the third and fourth wheels 13 and 14.

Any one of the brake modules 110 and 120 associated with the front wheels 11 and 12 may fail, or any one of the brake modules 130, and 140 associated with the rear wheels 13, and 14 may fail.

In response to the total required braking torque exceeding the maximum regenerative braking torque of the driving device 20 and any one of the brake modules failing, the brake controller 150 may request the maximum regenerative braking from the driving motor of the axle having the brake module with failure and transmit the braking signal to the brake modules of the axle having the brake module without failure to generate the difference between the total required braking torque and the maximum regenerative braking of the driving motor.

As illustrated in FIG. 8A, the brake controller 150 may identify the failure of the first brake module 110 associated with the front first wheel 11. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first and second driving motors 21 and 22 generates the braking torque of 2 kNm, which is the maximum regenerative braking torque. Moreover, the brake controller 150 may transmit the braking signal corresponding to the braking torque of 2 kNm to each of the third brake module 130 and the fourth brake module 140 so that the third and fourth brake modules 130 and 140 generate the braking torque of 4 kNm, which is the difference between the total required braking torque and the maximum regenerative braking torque.

Accordingly, the brake device 100 may compensate for the lack of the braking torque due to the failure of the brake module, and also prevent the biased braking due to the failure of the brake module.

As illustrated in FIG. 8B, the brake controller 150 may identify the failure of the third brake module 130 associated with the front third wheel 13. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first and second driving motors 21 and 22 generates the braking torque of 2 kNm, which is the maximum regenerative braking torque. Moreover, the brake controller 150 may transmit the braking signal corresponding to the braking torque of 2 kNm to each of the first brake module 110 and the second brake module 120 so that the first and second brake modules 110 and 120 generate the braking torque of 4 kNm, which is the difference between the total required braking torque and the maximum regenerative braking torque.

Accordingly, the brake device 100 may compensate for the lack of the braking torque due to the failure of the brake module, and also prevent the biased braking due to failure of the brake module.

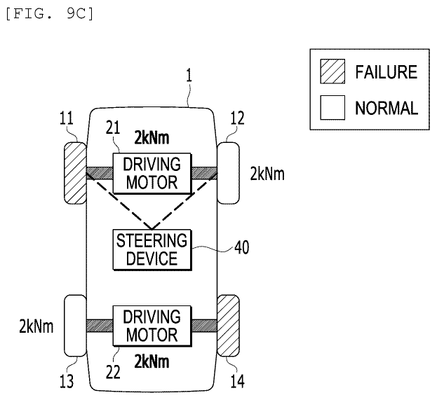

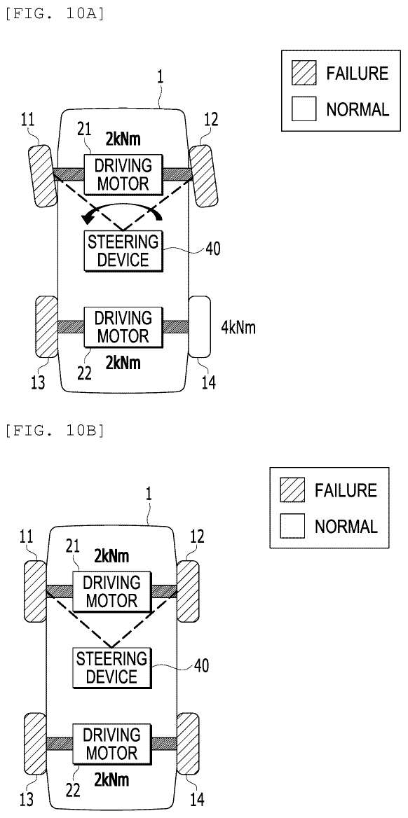

FIGS. 9A, 9B, and 9C illustrate an example of the brake device according to one embodiment of the present disclosure cooperating with the driving device and the steering device in response to the failures of any two brake modules.

As illustrated in FIGS. 9A, 9B, and 9C, the vehicle 1 may include the driving device 20 and the steering device 40. The driving device 20 may include the first driving motor 21 that drives the first and second wheels 11 and 12 and the second driving motor 22 that drives the third and fourth wheels 13 and 14.

The brake modules (the first brake module and the second brake module, the third brake module and the fourth brake module) located on the same axle may fail, or the brake modules (the first brake module and the third brake module, the second brake module and the fourth brake module) provided on the same side of different axles may fail. Alternatively, the brake modules (the first brake module and the fourth brake module, the second brake module and the third brake module) located on different sides of different axles may fail.

In response to the total required braking torque exceeding the maximum regenerative braking torque of the driving device 20 and the brake modules located on the same axle failing, the brake controller 150 may transmit the signal to the driving motor of the axle having the brake module with failure to generate the maximum regenerative braking torque and transmit the braking signal to the brake modules without failure to generate the difference between the total required braking torque and the maximum regenerative braking of the driving motor.

As illustrated in FIG. 9A, the brake controller 150 may identify the failures of the first and second brake modules 110 and 120 associated with the front first and second wheels 11 and 12. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first and second driving motors 21 and 22 generates the braking torque of 2 kNm, which is the maximum regenerative braking torque. Additionally, the brake controller 150 may transmit the braking signal corresponding to the braking torque of 2 kNm to each of the third brake module 130 and the fourth brake module 140 so that the third and fourth brake modules 130 and 140 generate the braking torque of 4 kNm, which is the difference between the total required braking torque and the maximum regenerative braking torque.

Accordingly, the brake device 100 may compensate for the lack of the braking torque due to the failure of the brake module.

In response to the total required braking torque exceeding the maximum regenerative braking torque of the driving device 20 and the brake modules provided on the same side of the different axles failing, the brake controller 150 may transmit the signal to the driving motor of the axle having the brake module with failure to generate the maximum regenerative braking torque and transmit the braking signal to the brake modules without failure to generate the difference between the total required braking torque and the maximum regenerative braking of the driving motor. In addition, the brake controller 150 may request the steering device 40 to steer in the direction opposite to the directions of the wheels without failure to prevent the turning of the vehicle 1 due to the biased braking of the wheels without failure.

The brake controller 150 may calculate a steering angle for preventing the turning of the vehicle 1 due to the biased braking based on the weight of the vehicle, road surface conditions, and/or the size of biased braking (braking torque), and transmit the steering signal including the calculated steering angle to the steering device 40. In addition, the brake controller 150 may transmit the steering signal for controlling the steering of the vehicle 1 to the steering device 40 based on the output signal of the motion sensor 70 including a yaw rate sensor.

As illustrated in FIG. 9B, the brake controller 150 may identify the failures of the first brake module 110 associated with the front first wheel 11 and the third brake module 130 associated with the rear third wheel 13. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first and second driving motors 21 and 22 generates the braking torque of 2 kNm, which is the maximum regenerative braking torque. In addition, the brake controller 150 may transmit the braking signal corresponding to the braking torque of 2 kNm to each of the second brake module 120 and the fourth brake module 140 so that the second and fourth brake modules 120 and 140 generate the braking torque of 4 kNm, which is the difference between the total required braking torque and the maximum regenerative braking torque. In addition, the brake controller 150 may request the steering device 40 to steer in the directions of the first and third wheels 11 and 13 in order to prevent the turning of the vehicle 1 due to the braking torque of 4 kNm of the second and fourth brake modules 120 and 140.

Accordingly, the brake device 100 may compensate for the lack of the braking torque due to the failure of the brake module, and also prevent the turning of the vehicle 1 due to the failure of the brake module.

In response to the total required braking torque exceeding the maximum regenerative braking torque of the driving device 20 and the brake modules located on different sides of different axles failing, the brake controller 150 may transmit the signal to the driving motor of the axle having the brake module with failure to generate the maximum regenerative braking torque and transmit the braking signal to the brake modules associated with the axle without failure to generate the difference between the total required braking torque and the maximum regenerative braking of the driving motor.

As illustrated in FIG. 9C, the brake controller 150 may identify the failures of the first brake module 110 associated with the front first wheel 11 and the fourth brake module 140 associated with the rear fourth wheel 14. For example, when the total required braking torque of the driver is 8 kNm (or the individual required braking torque is 2 kNm) and the maximum regenerative braking torque of the driving device 20 is 4 kNm, the brake controller 150 may request the regenerative braking to the driving device 20 so that each of the first and second driving motors 21 and 22 generates a braking torque of 2 kNm, which is the maximum regenerative braking torque. Additionally, the brake controller 150 may transmit the braking signal corresponding to the braking torque of 2 kNm to each of the second brake module 120 and the third brake module 130 so that the second and third brake modules 120 and 130 generate the braking torque of 4 kNm, which is the difference between the total required braking torque and the maximum regenerative braking torque.

Accordingly, the brake device 100 may compensate for the lack of the braking torque due to the failure of the brake module.

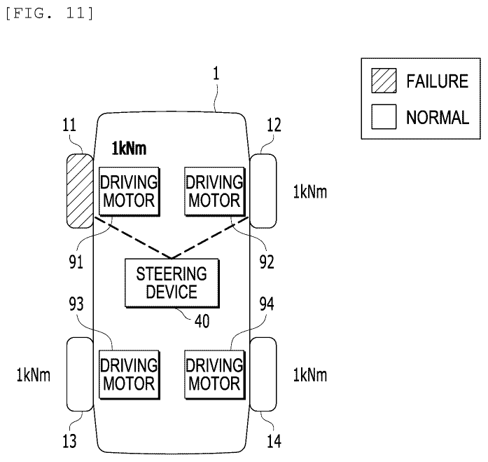

FIGS. 10A and 10B illustrate an example of the brake device according to one embodiment of the present disclosure cooperating with the driving device and the steering device in response to the failures of three or more brake modules.

As illustrated in FIGS. 10A and 10B, the vehicle 1 may include the driving device 20 and the steering device 40. The driving device 20 may include the first driving motor 21 that drives the first and second wheels 11 and 12 and the second driving motor 22 that drives the third and fourth wheels 13 and 14.

In response to the total required braking torque exceeding the maximum regenerative braking torque of the driving device 20 and three brake modules failing, the brake controller 150 may transmit the signal to the driving motor of the axle having the brake module with failure to generate the maximum regenerative braking torque and may transmit the braking signal to the brake module without failure to generate the difference between the total required braking torque and the maximum regenerative braking of the driving motor. In addition, the brake controller 150 may request the steering device 40 to steer in the direction opposite to the direction of the wheel without failure to prevent the turning of the vehicle 1 due to the biased braking of the wheel without failure.

As illustrated in FIG. 10A, the brake controller 150 may identify the failures of the first, second, and third brake modules 110, 120, and 130 associated with the first, second, and third wheels 11, 12, and 13. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first and second driving motors 21 and 22 generates the braking torque of 2 kNm, which is the maximum regenerative braking torque. In addition, the brake controller 150 may transmit the braking signal corresponding to the braking torque of 4 kNm to the fourth brake module 140 so that the fourth brake modules 140 generate the braking torque of 4 kNm, which is the difference between the total required braking torque and the maximum regenerative braking torque. In addition, the brake controller 150 may request the steering device 40 to steer in the directions of the first and third wheels 11 and 13 to prevent the turning of the vehicle 1 due to the braking torque of 4 kNm of the fourth brake module 140.

Accordingly, the brake device 100 may compensate for the lack of the braking torque due to the failure of the brake module, and also prevent the turning of the vehicle 1 due to the failure of the brake module.

In response to the total required braking torque exceeding the maximum regenerative braking torque of the driving device 20 and all brake modules failing, the brake controller 150 may transmit the signal to the driving motor of the axle having the brake module with failure to generate the maximum regenerative braking torque.

As illustrated in FIG. 10B, the brake controller 150 may identify the failures of all brake modules 110, 120, 130, and 140 associated with all wheels 11, 12, 13, and 14. The brake controller 150 may request the regenerative braking of all driving motors 21 and 22 from the driving device 20 to generate the required braking torques of all wheels 11, 12, 13, and 14.

Accordingly, the brake device 100 may provide the braking torque reduced by the failure of the brake module.

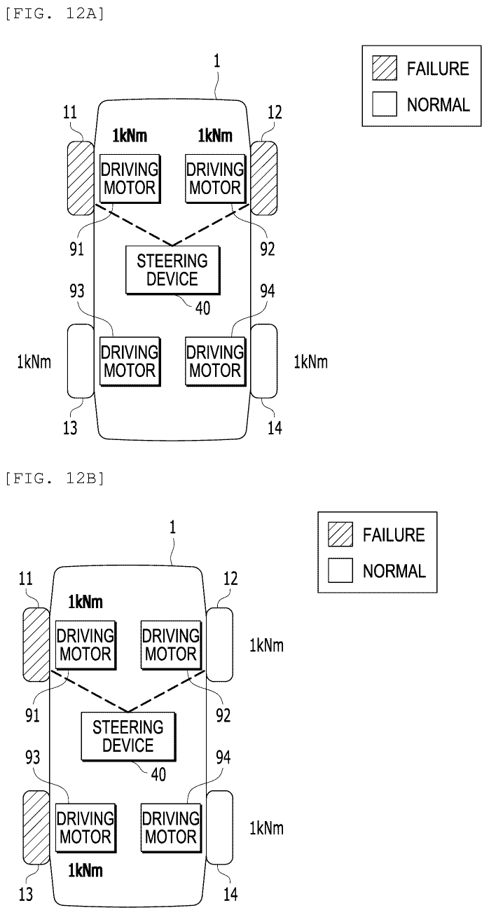

FIG. 11 illustrates an example of the brake device according to one embodiment of the present disclosure cooperating with the driving device in response to the failure of any one brake module.

As illustrated in FIG. 11, the vehicle 1 may include the driving device 20 and the steering device 40. The driving device 20 may include a first driving motor 91 that drives the first wheel 11, a second driving motor 92 that drives the second wheel 12, a third driving motor 93 that drives the third wheel 13, and a fourth driving motor 94 that drives the fourth wheel 14.

In response to the total required braking torque being less than or equal to the maximum regenerative braking torque of the driving device 20 and any one of the brake modules failing, the brake controller 150 may transmit the regenerative braking signal to the driving device 20 so that the driving motor of the wheel having the brake module with failure generates the regenerative braking torque corresponding to the required braking torque of the wheel having the brake module with failure, and transmit the braking signal corresponding to the individual required braking torque to the brake modules without failure.

As illustrated in FIG. 11, the first brake module 110 associated with the front first wheel 11 may fail. For example, when the total required braking torque of the driver is 4 kNm (or the individual required braking torque is 1 kNm) and the maximum regenerative braking torque of the driving device 20 is 4 kNm, the brake controller 150 may request the regenerative braking of the first driving motor 21 from the driving device 20 to generate braking torque of 1 kNm, which is the required braking torque of the first wheel 11. In addition, the brake controller 150 may transmit the braking signal to each of the second, third, and fourth brake modules 120, 130, and 140 to generate braking torque of 1 kNm, which is the required braking torque of each of the second, third, and fourth wheels 12, 13, and 14.

Accordingly, the brake device 100 may compensate for the lack of braking torque due to the failure of the brake module, and also prevent the biased braking due to the failure of the brake module.

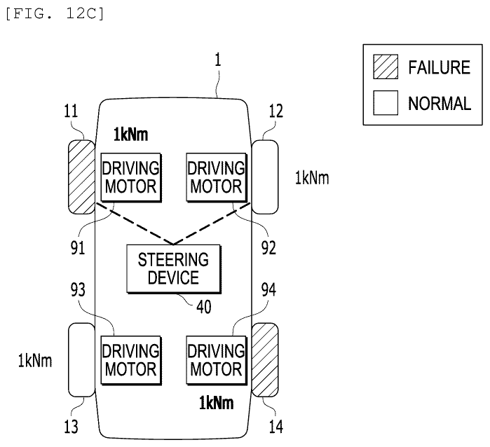

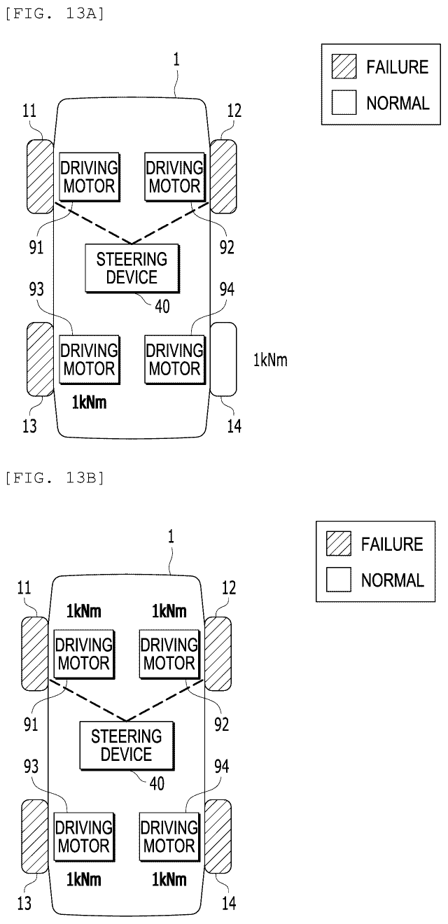

FIGS. 12A, 12B, and 12C illustrate an example of the brake device according to one embodiment of the present disclosure cooperating with the driving device and the steering device in response to the failures of any two brake modules.

As illustrated in FIGS. 12A, 12B, and 12C, the vehicle 1 may include the driving device 20 and the steering device 40. The driving device 20 may include the first driving motor 91 that drives the first wheel 11, the second driving motor 92 that drives the second wheel 12, the third driving motor 93 that drives the third wheel 13, and the fourth driving motor 94 that drives the fourth wheel 14.

The brake modules (the first brake module and the second brake module, the third brake module and the fourth brake module) located on the same axle may fail, or the brake modules (the first brake module and the third brake module, the second brake module and the fourth brake module) located on the same side of different axles may fail. Alternatively, the brake modules (the first brake module and the fourth brake module, the second brake module and the third brake module) located on different sides of different axles may fail.

In response to the total required braking torque being less than or equal to the maximum regenerative braking torque of the driving device 20 and two brake modules failing, the brake controller 150 may transmit the regenerative braking signal to the driving device 20 so that the driving motors of the wheels having the brake module with failure generate the regenerative braking torque corresponding to the required braking torques of the wheels having the brake module with failure and transmit the braking signals corresponding to the individual required braking torques to the brake modules without failure.

As illustrated in FIG. 12A, the brake controller 150 may identify the failures of the first and second brake modules 110 and 120 associated with the front first and second wheels 11 and 12. For example, when the total required braking torque of the driver is 4 kNm (or the individual required braking torque is 1 kNm) and the maximum regenerative braking torque of the driving device 20 is 4 kNm, the brake controller 150 may request the regenerative braking of the first and second driving motors 91 and 92 to the driving device 20 to generate the braking torque of 1 kNm, which is the required braking torque of each of the first and second wheels 11 and 12. Moreover, the brake controller 150 may transmit the braking signal to each of the third and fourth brake modules 130 and 140 to generate the braking torque of 1 kNm, which is the required braking torque of each of the third and fourth wheels 13 and 14.

Accordingly, the brake device 100 may compensate for the lack of the braking torque due to the failure of the brake module.

As illustrated in FIG. 12B, the brake controller 150 may identify the failures of the first and third brake modules 110 and 130 associated with the front first and third wheels 11 and 13. For example, when the total required braking torque of the driver is 4 kNm (or the individual required braking torque is 1 kNm) and the maximum regenerative braking torque of the driving device 20 is 4 kNm, the brake controller 150 may request the regenerative braking of the first and third driving motors 91 and 93 from the driving device 20 to generate braking torque of 1 kNm, which is the required braking torque of each of the first and third wheels 11 and 13. Moreover, the brake controller 150 may transmit the braking signal to each of the second and fourth brake modules 120 and 140 to generate the braking torque of 1 kNm, which is the required braking torque of each of the second and fourth wheels 12 and 14.

Accordingly, the brake device 100 may compensate for the lack of the braking torque due to the failure of the brake module.

As illustrated in FIG. 12C, the brake controller 150 may identify the failures of the first and fourth brake modules 110 and 140 associated with the front first and fourth wheels 11 and 14. For example, when the total required braking torque of the driver is 4 kNm (or the individual required braking torque is 1 kNm) and the maximum regenerative braking torque of the driving device 20 is 4 kNm, the brake controller 150 may request the regenerative braking of the first and fourth driving motors 91 and 94 from the driving device 20 to generate braking torque of 1 kNm, which is the required braking torque of each of the first and fourth wheels 11 and 14. Moreover, the brake controller 150 may transmit the braking signal to each of the second and third brake modules 120 and 130 to generate the braking torque of 1 kNm, which is the required braking torque of each of the second and third wheels 12 and 13.

Accordingly, the brake device 100 may compensate for the lack of the braking torque due to the failure of the brake module.

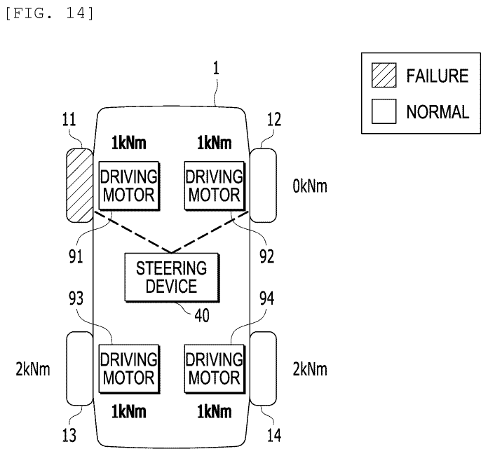

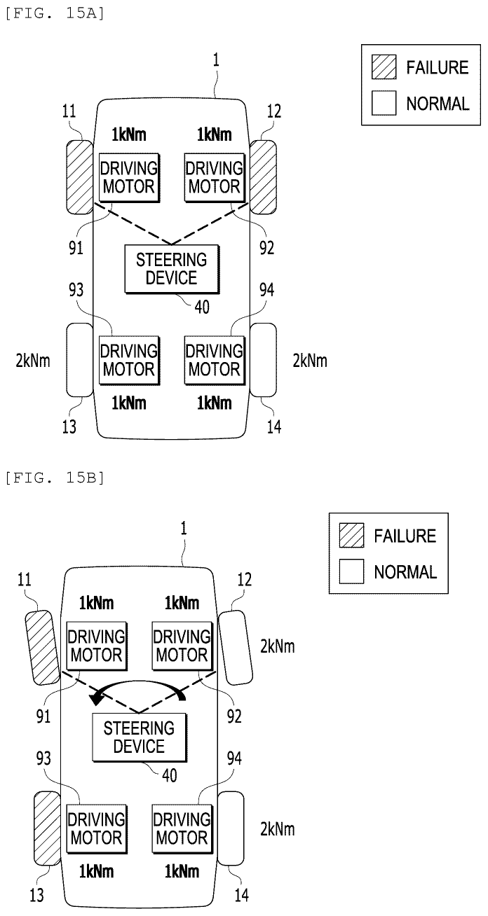

FIGS. 13A and 13B illustrate an example of the brake device according to one embodiment of the present disclosure cooperating with the driving device and the steering device in response to failure of three or more brake modules.

As illustrated in FIGS. 13A and 13B, the vehicle 1 may include the driving device 20 and the steering device 40. The driving device 20 may include the first driving motor 91 that drives the first wheel 11, the second driving motor 92 that drives the second wheel 12, the third driving motor 93 that drives the third wheel 13, and the fourth driving motor 94 that drives the fourth wheel 14.

In response to the total required braking torque being less than or equal to the maximum regenerative braking torque of the driving device 20 and three or more brake modules failing, the brake controller 150 may transmit the regenerative braking signal to the driving device 20 so that the driving motor of the wheel having the brake module with failure generates the regenerative braking torque corresponding to the required braking torque of the wheel having the brake module with failure and may transmit the braking signals corresponding to the individual required braking torques to the brake modules without failure.

As illustrated in FIG. 13A, the brake controller 150 may identify the failures of the first, second, and third brake modules 110, 120, and 130 associated with the first, second, and third wheels 11, 12, and 13. For example, when the total required braking torque is 4 kNm (or the individual required braking torque is 1 kNm) and the maximum regenerative braking torque of the driving device 20 is 4 kNm, the brake controller 150 may request the regenerative braking of the first, second, and third driving motors 91, 92 and 93 from the driving device 20 to generate the braking torque of 1 kNm, which is the required braking torque of each of the first, second, and third wheels 11, 12, and 13. Moreover, the brake controller 150 may transmit the braking signal to the fourth brake module 140 to generate a braking torque of 1 kNm, which is the required braking torque of the fourth wheel 14.

Accordingly, the brake device 100 may compensate for the lack of the braking torque due to the failure of the brake module, and also prevent the biased braking due to the failure of the brake module in the same direction of different axles.

As illustrated in FIG. 13B, the brake controller 150 may identify the failures of all brake modules 110, 120, 130, and 140 associated with all wheels 11, 12, 13, and 14. The brake controller 150 may request the regenerative braking of all driving motors 91, 92, 93, and 94 from the driving device 20 to generate the required braking torque of all wheels 11, 12, 13, and 14.

Accordingly, the brake device 100 may provide the braking torque reduced by the failure of the brake module.

FIG. 14 illustrates an example of the brake device according to one embodiment of the present disclosure cooperating with the driving device in response to the failure of any one brake module.

As illustrated in FIG. 14, the vehicle 1 may include the driving device 20 and the steering device 40. The driving device 20 may include the first driving motor 91 that drives the first wheel 11, the second driving motor 92 that drives the second wheel 12, the third driving motor 93 that drives the third wheel 13, and the fourth driving motor 94 that drives the fourth wheel 14.

In response to the total required braking torque exceeding the maximum regenerative braking torque of the driving device 20 and any one of the brake modules failing, the brake controller 150 may request the maximum regenerative braking from the driving motors of the axle having the brake module with failure and transmit the braking signal to the brake modules of the axle having the brake module without failure to generate the difference between the total required braking torque and the maximum regenerative braking of the driving motors.

As illustrated in FIG. 14, the brake controller 150 may identify the failure of the first brake module 110 associated with the front first wheel 11. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first, second, third, and fourth driving motors 91, 92, 93, and 94 generates a braking torque of 1 kNm, which is the maximum regenerative braking torque. Moreover, the brake controller 150 may transmit the braking signal corresponding to the braking torque of 2 kNm to each of the third brake module 130 and the fourth brake module 140 so that the third and fourth brake modules 130 and 140 generate a braking torque of 4 kNm, which is the difference between the total required braking torque and the maximum regenerative braking torque.

Accordingly, the brake device 100 may compensate for the lack of the braking torque due to the failure of the brake module, and also prevent the biased braking due to the failure of the brake module.

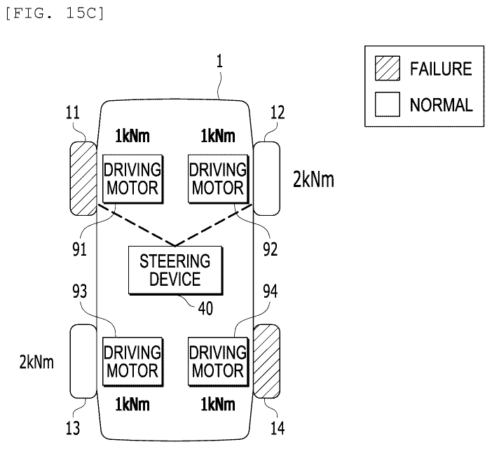

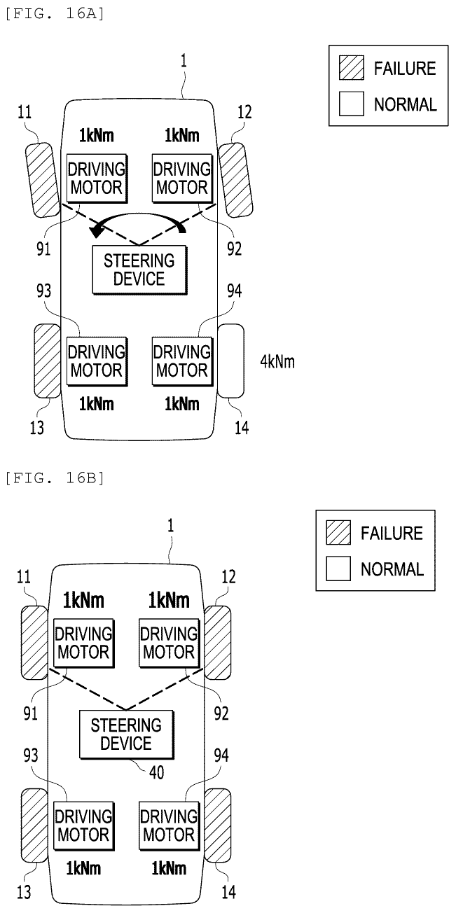

FIGS. 15A, 15B, and 15C illustrate an example of the brake device according to one embodiment of the present disclosure cooperating with the driving device and the steering device in response to the failures of any two brake modules.

As illustrated in FIGS. 15A, 15B, and 15C, the vehicle 1 may include the driving device 20 and the steering device 40. The driving device 20 may include the first driving motor 91 that drives the first wheel 11, the second driving motor 92 that drives the second wheel 12, the third driving motor 93 that drives the third wheel 13, and the fourth driving motor 94 that drives the fourth wheel 14.

The brake modules (the first brake module and the second brake module, the third brake module and the fourth brake module) located on the same axle may fail, or the brake modules (the first brake module and the third brake module, the second brake module and the fourth brake module) located on the same side of different axles may fail. Alternatively, the brake modules (the first brake module and the fourth brake module, the second brake module and the third brake module) located on different sides of different axles may fail.

In response to the total required braking torque exceeding the maximum regenerative braking torque of the driving device 20 and the brake modules (the first brake module and the second brake module, the third brake module and the fourth brake module) located on the same axle failing, the brake controller 150 may transmit the signal to the driving motor of the axle having the brake module with failure to generate the maximum regenerative braking torque and transmit the braking signal to the brake modules without failure to generate the difference between the total required braking torque and the maximum regenerative braking of the driving motor.

As illustrated in FIG. 15A, the brake controller 150 may identify the failures of the first and second brake modules 110 and 120 associated with the front first and second wheels 11 and 12. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first, second, third and fourth driving motors 91, 92, 93, and 94 generates a braking torque of 1 kNm, which is the maximum regenerative braking torque. Moreover, the brake controller 150 may transmit the braking signal corresponding to the braking torque of 2 kNm to each of the third brake module 130 and the fourth brake module 140 so that the third and fourth brake modules 130 and 140 generate the braking torque of 4 kNm, which is the difference between the total required braking torque and the maximum regenerative braking torque.

Accordingly, the brake device 100 may compensate for the lack of the braking torque due to the failure of the brake module.

In response to the total required braking torque exceeding the maximum regenerative braking torque of the driving device 20 and the brake modules (the first brake module and the third brake module, the second brake module and the fourth brake module) provided on the same side of the different axles failing, the brake controller 150 may transmit the signal to the driving motor of the wheel having the brake module with failure to generate the maximum regenerative braking torque and transmit the braking signal to the brake modules without failure to generate the difference between the total required braking torque and the maximum regenerative braking of the driving motor. In addition, the brake controller 150 may request the steering device 40 to steer in the direction opposite to the directions of the wheels without failure to prevent the turning of the vehicle 1 due to the biased braking of the wheels without failure.

As illustrated in FIG. 15B, the brake controller 150 may identify the failures of the first brake module 110 associated with the front first wheel 11 and the third brake module 130 associated with the rear third wheel 13. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first, second, third, and fourth driving motors 91, 92, 93, and 94 generates braking torque of 1 kNm, which is the maximum regenerative braking torque. In addition, the brake controller 150 may transmit the braking signal corresponding to the braking torque of 2 kNm to each of the second brake module 120 and the fourth brake module 140 so that the second and fourth brake modules 120 and 140 generate the braking torque of 4 kNm, which is a difference between the total required braking torque and the maximum regenerative braking torque. In addition, the brake controller 150 may request the steering device 40 to steer in the direction of the first and third wheels 11 and 13 in order to prevent the turning of the vehicle 1 due to the braking torque of 4 kNm of the second and fourth brake modules 120 and 140.

Accordingly, the brake device 100 may compensate for the lack of the braking torque due to the failure of the brake module, and also prevent the turning of the vehicle 1 due to failure of the brake module.

In response to the total required braking torque exceeding the maximum regenerative braking torque of the driving device 20 and the brake modules (the first brake module and the fourth brake module, the second brake module and the third brake module) located on different sides of different axles failing, the brake controller 150 may transmit the signal to the driving motor of the axle having the brake module with failure to generate the maximum regenerative braking torque and transmit the braking signal to the brake modules associated with the axle without failure to generate the difference between the total required braking torque and the maximum regenerative braking of the driving motor.

As illustrated in FIG. 15C, the brake controller 150 may identify the failures of the first brake module 110 associated with the front first wheel 11 and the fourth brake module 140 associated with the rear fourth wheel 14. For example, when the total required braking torque of the driver is 8 kNm (or the individual required braking torque is 2 kNm) and the maximum regenerative braking torque of the driving device 20 is 4 kNm, the brake controller 150 may request the regenerative braking from the driving device 20 so that each of the first, second, third, and fourth driving motors 91, 92, 93, and 94 generates braking torque of 1 kNm, which is the maximum regenerative braking torque. Moreover, the brake controller 150 may transmit the braking signal corresponding to the braking torque of 2 kNm to each of the second brake module 120 and the third brake module 130 so that the second and third brake modules 120 and 130 generate the braking torque of 4 kNm, which is the difference between the total required braking torque and the maximum regenerative braking torque.

Accordingly, the brake device 100 may compensate for the lack of the braking torque due to the failure of the brake module.

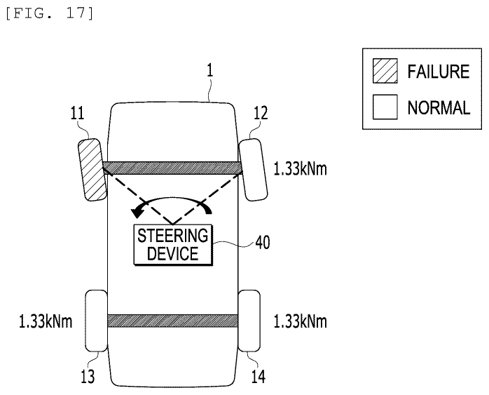

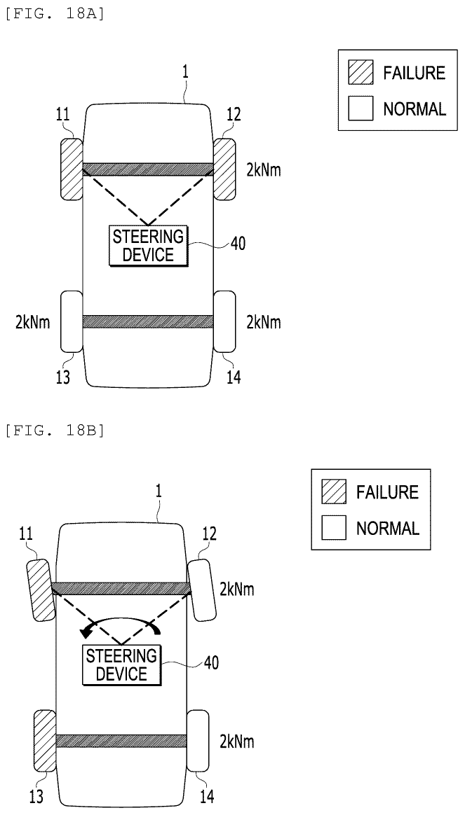

FIGS. 16A and 16B illustrate an example of the brake device according to one embodiment of the present disclosure cooperating with the driving device and the steering device in response to the failures of three or more brake modules.

As illustrated in FIGS. 16A and 16B, the vehicle 1 may include the driving device 20 and the steering device 40. The driving device 20 may include the first driving motor 91 that drives the first wheel 11, the second driving motor 92 that drives the second wheel 12, the third driving motor 93 that drives the third wheel 13, and the fourth driving motor 94 that drives the fourth wheel 14.

In response to the total required braking torque exceeding the maximum regenerative braking torque of the driving device 20 and three brake modules failing, the brake controller 150 may transmit the signal to the driving motor of the axle having the brake module with failure to generate the maximum regenerative braking torque and may transmit the braking signal to the brake module without failure to generate the difference between the total required braking torque and the maximum regenerative braking of the driving motor. In addition, the brake controller 150 may request the steering device 40 to steer in the direction opposite to the direction of the wheel without failure to prevent the turning of the vehicle 1 due to biased braking of the wheel without failure.

As illustrated in FIG. 16A, the brake controller 150 may identify the failures of the first, second, and third brake modules 110, 120, and 130 associated with the first, second, and third wheels 11, 12, and 13. For example, when the total required braking torque of the driver is 8 kNm (or the individual required braking torque is 2 kNm) and the maximum regenerative braking torque of the driving device 20 is 4 kNm, the brake controller 150 may request the regenerative braking to the driving device 20 so that each of the first, second, third, and fourth driving motors 91, 92, 93, and 94 generates the braking torque of 1 kNm, which is the maximum regenerative braking torque. In addition, the brake controller 150 may transmit the braking signal corresponding to the braking torque of 4 kNm to the fourth brake module 140 so that the fourth brake modules 140 generate the braking torque of 4 kNm, which is the difference between the total required braking torque and the maximum regenerative braking torque. In addition, the brake controller 150 may request the steering device 40 to steer in the directions of the first and third wheels 11 and 13 to prevent the turning of the vehicle 1 due to the braking torque of 4 kNm of the fourth brake module 140.

Accordingly, the brake device 100 may compensate for the lack of the braking torque due to the failure of the brake module, and also prevent the turning of the vehicle 1 due to the failure of the brake module.

In response to the total required braking torque exceeding the maximum regenerative braking torque of the driving device 20 and all brake modules failing, the brake controller 150 may transmit the signal to the driving motor of the axle having the brake module with failure to generate the maximum regenerative braking torque.

As illustrated in FIG. 16B, the brake controller 150 may identify the failures of all brake modules 110, 120, 130, and 140 associated with all wheels 11, 12, 13, and 14. The brake controller 150 may request the regenerative braking of all driving motors 91, 92, 93, and 94 from the driving device 20 to generate the required braking torques of all wheels 11, 12, 13, and 14.

Accordingly, the brake device 100 may provide the braking torque reduced by the failure of the brake module.

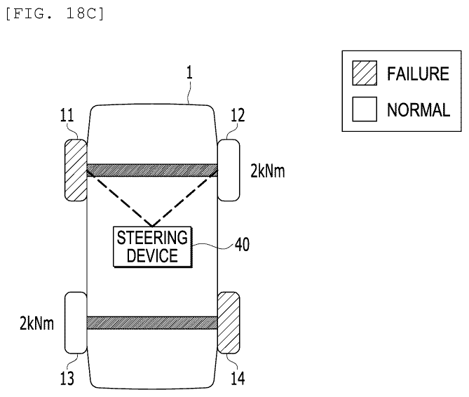

FIG. 17 illustrates an example of the brake device according to one embodiment of the present disclosure cooperating with the steering device in response to the failure of any one brake module.

As illustrated in FIG. 17, the vehicle 1 may include the steering device 40, and the regenerative braking of the vehicle 1 may not be permitted.

Any one of the brake modules 110, 120, 130, and 140 may fail.

In response to regenerative braking not being permitted and any one of the brake modules failing, the brake controller 150 may distribute the total required braking torque to the brake modules without failure. Moreover, the brake controller 150 may request the steering device 40 to steer in the direction opposite to the directions of the wheels without failure to prevent the turning of the vehicle 1 due to the biased braking of the wheels without failure.

As illustrated in FIG. 17, the brake controller 150 may identify the failure of the first brake module 110 associated with the front first wheel 11. For example, when the total required braking torque of the driver is 4 kNm (or the individual required braking torque is 1 kNm), the brake controller 150 may transmit the braking signal corresponding to the braking torque of 1.33 kNm to each of the second, third, and fourth brake modules 120, 130, and 140. In addition, the brake controller 150 may request the steering device 40 to steer in the directions of the first and third wheels 11 and 13 in order to prevent the turning of the vehicle 1 due to the braking torque of the second brake modules 120.

Accordingly, the brake device 100 may compensate for the lack of the braking torque due to the failure of the brake module, and also prevent the turning of the vehicle 1 due to the failure of the brake module.

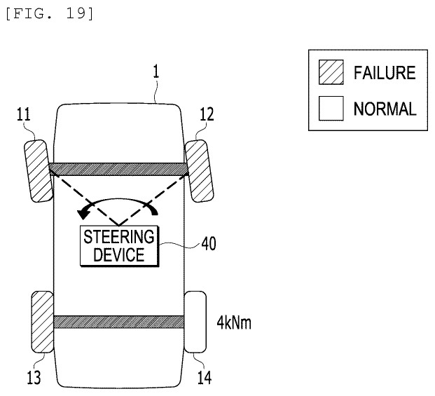

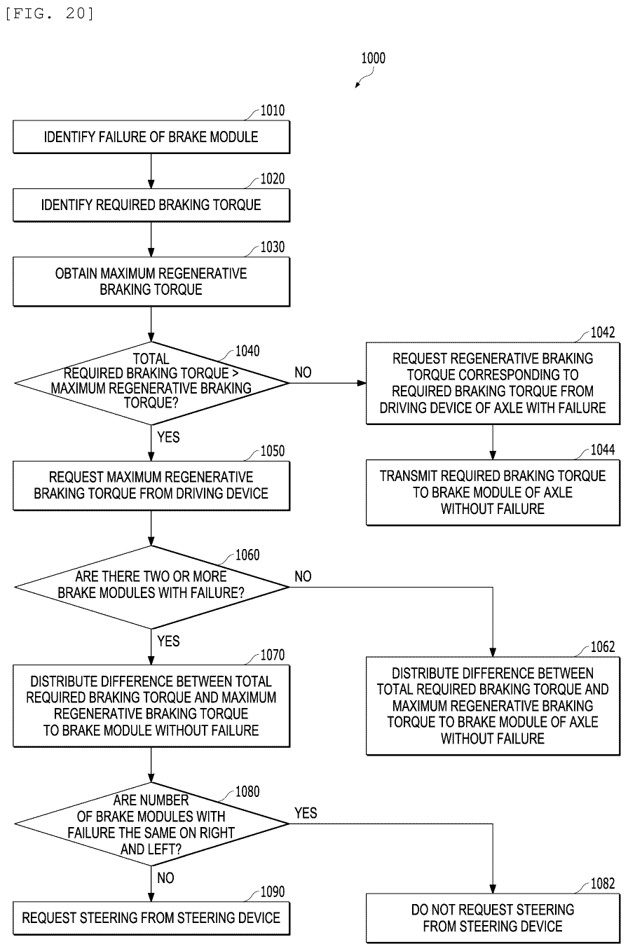

FIGS. 18A, 18B, and 18C illustrate an example of the brake device according to one embodiment of the present disclosure cooperating with the steering device in response to failure of any two brake modules.

As illustrated in FIGS. 18A, 18B, and 18C, the vehicle 1 may include the steering device 40, and the regenerative braking of the vehicle 1 may not be permitted.

The brake modules (the first brake module and the second brake module, the third brake module and the fourth brake module) located on the same axle may fail, or the brake modules (the first brake module and the third brake module, the second brake module and the fourth brake module) located on the same side of different axles may fail. Alternatively, the brake modules (the first brake module and the fourth brake module, the second brake module and the third brake module) located on different sides of different axles may fail.

In response to the regenerative braking not being permitted and the two brake modules failing, the brake controller 150 may distribute the total required braking torque to the brake modules without failure.

As illustrated in FIG. 18A, the brake controller 150 may identify the failures of the first and second brake modules 110 and 120 associated with the first and second wheels 11 and 12. For example, when the total required braking torque of the driver is 4 kNm (or the individual required braking torque is 1 kNm), the brake controller 150 may transmit the braking signal to each of the third and fourth brake modules 130 and 140 to generate a braking torque of 2 kNm for each of the third and fourth wheels 13 and 14.

Accordingly, the brake device 100 may compensate for the lack of the braking torque due to the failure of the brake module.

As illustrated in FIG. 18B, the brake controller 150 may identify the failures of the first and third brake modules 110 and 130 associated with the first and third wheels 11 and 13. For example, when the total required braking torque of the driver is 4 kNm (or the individual required braking torque is 1 kNm), the brake controller 150 may transmit a braking signal to each of the second and fourth brake modules 120 and 140 to generate a braking torque of 2 kNm for each of the second and fourth wheels 12 and 14. In addition, the brake controller 150 may request the steering device 40 to steer in the directions of the first and third wheels 11 and 13 to prevent the turning of the vehicle 1 due to the braking torque of the second and fourth brake modules 120 and 140.

Accordingly, the brake device 100 may compensate for the lack of the braking torque due to the failure of the brake module, and also prevent the biased braking due to the failure of the brake module in the same direction of different axles.

As illustrated in FIG. 18C, the brake controller 150 may identify the failures of the first and fourth brake modules 110 and 140 associated with the first and fourth wheels 11 and 14. For example, when the total required braking torque of the driver is 4 kNm (or the individual required braking torque is 1 kNm), the brake controller 150 may transmit the braking signal to each of the second and fourth brake modules 120 and 140 to generate a braking torque of 2 kNm for each of the second and fourth wheels 12 and 14.

Accordingly, the brake device 100 may compensate for the lack of the braking torque due to the failure of the brake module.

FIG. 19 illustrates an example of the brake device according to one embodiment of the present disclosure cooperating with the steering device in response to the failures of three or more brake modules.

As illustrated in FIG. 19, the vehicle 1 may include the steering device 40, and the regenerative braking of the vehicle 1 may not be permitted.

In response to the regenerative braking of the vehicle 1 not being permitted and three or more brake modules failing, the brake controller 150 may transmit the braking signal to the brake module without failure to generate the difference between the total required braking torque and the maximum regenerative braking of the driving motor. In addition, the brake controller 150 may request the steering device 40 to steer in the direction opposite to the direction of the wheel without failure to prevent the turning of the vehicle 1 due to the biased braking of the wheel without failure.

As illustrated in FIG. 19, the brake controller 150 may identify the failures of the first, second, and third brake modules 110, 120, and 130 associated with the first, second, and third wheels 11, 12, and 13. For example, when the total required braking torque of the driver is 4 kNm (or the individual required braking torque is 2 kNm), the brake controller 150 may transmit the braking signal corresponding to the braking torque of 4 kNm to the fourth brake module 140 so that the fourth brake modules 140 generate the braking torque of 4 kNm, which is the total required braking torque. In addition, the brake controller 150 may request the steering device 40 to steer in the directions of the first and third wheels 11 and 13 in order to prevent the turning of the vehicle 1 due to the braking torque of 4 kNm of the fourth brake module 140.

Accordingly, the brake device 100 may compensate for the lack of the braking torque due to the failure of the brake module, and also prevent the turning of the vehicle 1 due to the failure of the brake module.

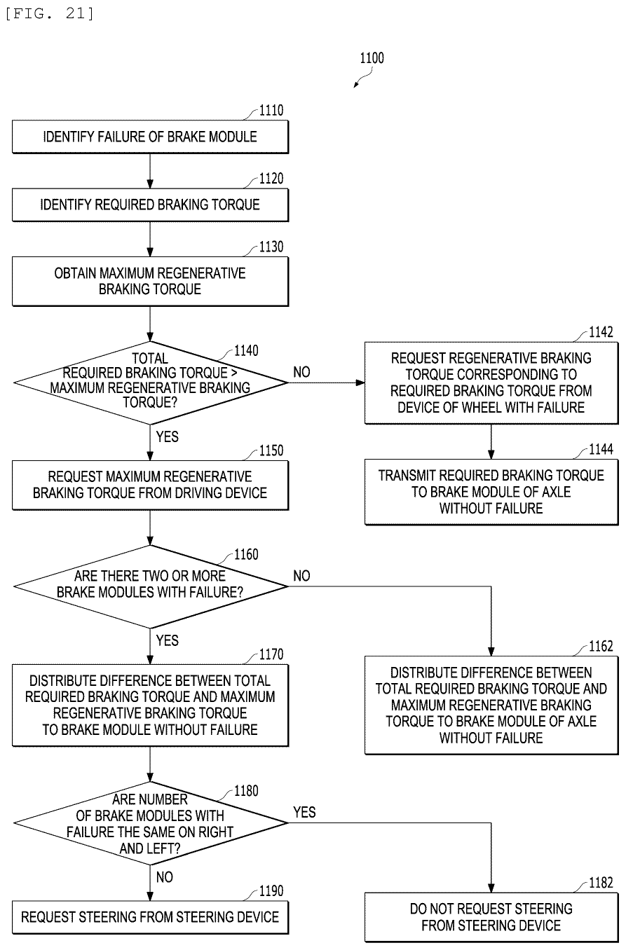

FIG. 20 illustrates an example of a method in which the brake device according to one embodiment of the present disclosure cooperates with the driving device and the steering device in response to the failure of the brake module. The operations illustrated in FIG. 20 are not essential operations, and at least some of these operations may be omitted.

With reference to FIG. 20, a method 1000 is described in which the brake device 100 cooperates with the driving device 20 and the steering device 40 in response to the failure of the brake module.

The vehicle 1 may include the driving device 20, the steering device 40, and/or the brake device 100. The driving device 20 includes the first driving motor 21 for driving the first axle and the second driving motor 22 for driving the second axle, and may be capable of performing the regenerative braking. The brake device 100 may include the brake controller 150 and the brake modules 110, 120, 130, and 140 associated with the wheels 11, 12, 13, and 14.

The brake device 100 may identify the failures of the brake modules 110, 120, 130, and 140 (1010).

The brake controller 150 may identify the failures of the brake modules 110, 120, 130, and 140 based on the signals from the motor controllers 113, 123, 133, and 143 or may identify the failures of the brake modules 110, 120, 130, and 140 based on the signals from the sensors.

The failures of the brake modules 110, 120, 130, and 140 may include the failures of the brakes 111, 121, 131 and 141, the failures of the brake motors 112, 122, 132 and 142, and/or the failures of the motor controllers 113, 123, 133, and 143.

The brake device 100 may identify the driver's required braking torque (1020).

The brake controller 150 may identify the individual required braking torque (or required braking force or required deceleration or required engagement force) of each wheel or the total required braking torque of the driver (for example, the sum of the individual required braking torques required for each wheel) based on the output signal of the pedal sensor 50.

The brake device 100 may obtain the maximum regenerative braking torque of the driving device 20 (1030).

The brake controller 150 may obtain the maximum regenerative braking torque of the driving motor in cooperation with the driving device 20. The maximum regenerative braking torque may vary, for example, depending on the traveling speed of the vehicle 1.

The brake device 100 may identify whether the total required braking torque of the driver exceeds the maximum regenerative braking torque of the driving device 20 (1040).

The brake controller 150 may compare the driver's required braking torque (total required braking torque or individual required braking torque) with the maximum regenerative braking torque of the driving device 20 and identify whether the total required braking torque of the driver exceeds the maximum regenerative braking torque of the driving device 20.

When the total required braking torque of the driver does not exceed the maximum regenerative braking torque of the driving device 20 (NO in 1040), the brake device 100 may request the regenerative braking torque corresponding to the required braking torque from the driving device of the axle with the failure (1042).

When the total required braking torque of the driver is less than or equal to the maximum regenerative braking torque of the driving device 20, the brake controller 150 may request the regenerative braking torque from the driving motor driving the axle associated with the brake module with failure. For example, when at least one of the first brake module 110 and the second brake module 120 associated with the first axle fails, the brake controller 150 may request the regenerative braking torque corresponding to the required braking torque of the first axle from the first driving motor 21 driving the first axle. As another example, when at least one of the third brake module 130 and the fourth brake module 140 associated with the second axle fails, the brake controller 150 may request the regenerative braking torque corresponding to the required braking torque of the second axle from the second driving motor 22 driving the second axle.

The brake device 100 may transmit the required braking torque to the brake module of the axle without failure (1044).

When the total required braking torque of the driver is less than or equal to the maximum regenerative braking torque of the driving device 20, the brake controller 150 may transmit the required braking torque to the brake modules associated with the axle without failure.

When one or two brake modules on an axle fail, the brake controller 150 may transmit the required braking torque to the brake modules associated with the axle without failure. For example, when at least one of the first brake module 110 and the second brake module 120 associated with the first axle fails, the brake controller 150 may transmit the required braking torque to the third and fourth brake modules 130 and 140 associated with the second axle. As another example, when at least one of the third brake module 130 and the fourth brake module 140 associated with the second axle fails, the brake controller 150 may transmit the required braking torque to the first and second brake modules 110 and 120 associated with the first axle.

When two brake modules or three or more brake modules on different axles fail, the brake controller 150 may not transmit the required braking torque to the brake modules.

When the total required braking torque of the driver exceeds the maximum regenerative braking torque of the driving device 20 (YES in 1040), the brake device 100 may request the maximum regenerative braking torque from the driving device 20 (1050).

When the total required braking torque of the driver exceeds the maximum regenerative braking torque of the driving device 20, the brake controller 150 may request the regenerative braking from the driving device 20 so that the first and second driving motors 21 and 22 generate the maximum regenerative braking torque.

The brake device 100 may identify whether there are two or more brake modules with failure (1060).

The brake controller 150 may identify whether the number of brake modules with failure is two or more.

When the number of brake modules with failure is not two or more (NO in 1060), the brake device 100 may transmit the difference between the total required braking torque and the maximum regenerative braking torque to the brake module of the axle without failure (1062).

When the total required braking torque of the driver exceeds the maximum regenerative braking torque of the driving device 20 and the number of brake modules with failure is one, the brake controller 150 may transmit the difference between the total required braking torque and the maximum regenerative braking torque to the brake module of the axle without failure. For example, when any one of the first brake module 110 and the second brake module 120 associated with the first axle fails, the brake controller 150 may transmit the difference between the total required braking torque and the maximum regenerative braking torque to the third and fourth brake modules 130 and 140 associated with the second axle. As another example, when at least one of the third brake module 130 and the fourth brake module 140 associated with the second axle fails, the brake controller 150 may transmit the difference between the total required braking torque and the maximum regenerative braking torque to the first and second brake modules 110 and 120 associated with the first axle.

When the number of brake modules with failure is one, the brake controller 150 may not transmit the braking signal to other brake modules of the same axle as the brake module with failure.

When the number of brake modules with failure is two or more (YES in 1060), the brake device 100 may transmit the difference between the total required braking torque and the maximum regenerative braking torque to the brake modules without failure (1070).

When the total required braking torque of the driver exceeds the maximum regenerative braking torque of the driving device 20 and the number of brake modules with failure is two or more, the brake controller 150 may transmit the difference between the total required braking torque and the maximum regenerative braking torque to the brake module without failure. For example, when two brake modules among the brake modules 110, 120, 130, and 140 fail, the brake controller 150 may transmit the difference between the total required braking torque and the maximum regenerative braking torque to the two brake modules without failure. As another example, when three brake modules of the brake modules 110, 120, 130, and 140 fail, the brake controller 150 may transmit the difference between the total required braking torque and the maximum regenerative braking torque to one brake module without failure. As another example, when four of the brake modules 110, 120, 130, and 140 fail, the brake controller 150 may not transmit the braking signal to the brake modules.

The brake device 100 may identify whether the number of brake modules with failure are the same on the right and left (1080).

When the total required braking torque of the driver exceeds the maximum regenerative braking torque of the driving device 20 and the number of brake modules with failure is two or more, the brake controller 150 may identify whether the number of brake modules with failure is the same on the right and left.

When the number of brake modules with failure is the same on the right and left (YES in 1080), the brake device 100 may operate without a steering request to the steering device 40 (1082).

When two brake modules on the same axle fail, or when brake modules on different sides of different axles fail, or when four brake modules fail, the brake device 100 may continue the braking operation without the steering request to the steering device 40.

When the number of brake modules with failure is not the same on the right and left (NO in 1080), the brake device 100 may request the steering device 40 to steer the vehicle 1 (1090).

When the brake module fails on the same side of a different axles, or when three brake modules fail, the brake device 100 may request the steering device 40 to steer the vehicle 1 in the direction opposite to the direction of the brake module without failure.

The brake controller 150 may calculate the steering angle for preventing the turning of the vehicle 1 due to the biased braking based on the weight of the vehicle, road surface conditions, and/or the size of biased braking (braking torque), and transmit the steering signal including the calculated steering angle to the steering device 40. In addition, the brake controller 150 may transmit the steering signal for controlling the steering of the vehicle 1 to the steering device 40 based on an output signal of the motion sensor 70 including a yaw rate sensor.

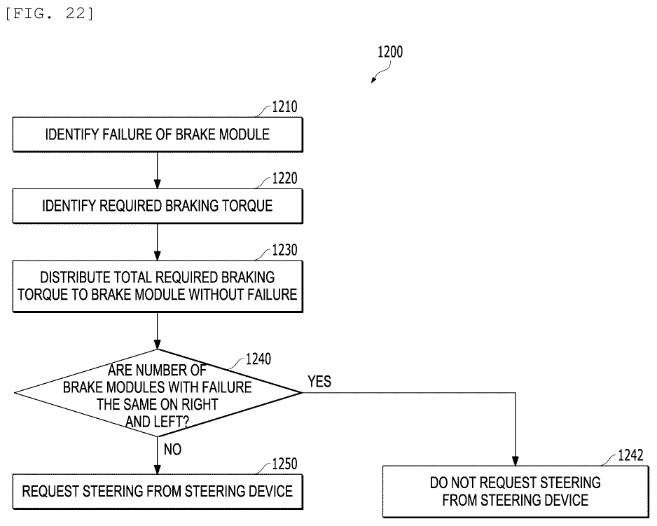

FIG. 21 illustrates an example of the brake device according to one embodiment of the present disclosure cooperating with the driving device and the steering device in response to the failure of the brake module. The operations illustrated in FIG. 21 are not essential operations, and at least some of these operations may be omitted.

With reference to FIG. 21, a method 1100 is described in which the brake device 100 cooperates with the driving device 20 and the steering device 40 in response to the failure of the brake module.

The vehicle 1 may include the driving device 20, the steering device 40, and/or the brake device 100. The driving device 20 includes the first driving motor 91 that drives the first wheel 11, the second driving motor 92 that drives the second wheel 12, the third driving motor 93 that drives the third wheel 13, and the fourth driving motor 94 that drives the fourth wheel 14, and may be capable of performing the regenerative braking. The brake device 100 may include the brake controller 150 and brake modules 110, 120, 130, and 140 associated with the wheels 11, 12, 13, and 14.

The brake device 100 may identify the failures of the brake modules 110, 120, 130, and 140 (1110). The operation 1110 may be identical to the operation 1010.

The brake device 100 may identify the driver's required braking torque (1120). The operation 1120 may be identical to the operation 1020.

The brake device 100 may obtain the maximum regenerative braking torque of the driving device 20 (1130). The operation 1130 may be identical to the operation 1030.

The brake device 100 may identify whether the total required braking torque of the driver exceeds the maximum regenerative braking torque of the driving device 20 (1140). The operation 1140 may be identical to the operation 1040.

When the total required braking torque of the driver does not exceed the maximum regenerative braking torque of the driving device 20 (NO in 1140), the brake device 100 may request the regenerative braking torque corresponding to the required braking torque from the driving device of the wheel with the failure (1142).

When the total required braking torque of the driver is less than or equal to the maximum regenerative braking torque of the driving device 20, the brake controller 150 may request the regenerative braking torque from the driving motor driving the wheel associated with the brake module with failure. For example, when the first brake module 110 associated with the first wheel 11 fails, the brake controller 150 may request the regenerative braking torque corresponding to the required braking torque from the first driving motor 91 driving the first wheel 11.

The brake device 100 may transmit the required braking torque to the brake module of the wheel without failure (1144).

When the total required braking torque of the driver is less than or equal to the maximum regenerative braking torque of the driving device 20, the brake controller 150 may transmit the required braking torque to the brake modules associated with the wheels without failure. For example, when the first brake module 110 associated with the first wheel 11 fails, the brake controller 150 may transmit the required braking torque to the second, third, and fourth brake modules 120, 130, and 140.

When the total required braking torque of the driver exceeds the maximum regenerative braking torque of the driving device 20 (YES in 1140), the brake device 100 may request the maximum regenerative braking torque from the driving device 20 (1150). The operation 1150 may be identical to the operation 1050.

The brake device 100 may identify whether the number of brake modules with failure is two or more (1160). The operation 1160 may be identical to the operation 1060.

When the number of brake modules with failure is not two or more (NO in 1160), the brake device 100 may transmit the difference between the total required braking torque and the maximum regenerative braking torque to the brake module of the axle without failure (1162). The operation 1162 may be identical to the operation 1160.

When the number of brake modules with failure is two or more (YES in 1160), the brake device 100 may transmit the difference between the total required braking torque and the maximum regenerative braking torque to the brake modules without failure (1170). The operation 1170 may be identical to the operation 1070.

The brake device 100 may identify whether the number of brake modules with failure is the same on the right and left (1180). The operation 1180 may be identical to the operation 1080.

When the number of brake modules with failure is the same on the right and left (YES in 1180), the brake device 100 may operate without the steering request from the steering device 40 (1182). The operation 1182 may be identical to the operation 1082.

When the number of brake modules with failure is not the same on the right and left (NO in 1180), the brake device 100 may request the steering device 40 to steer the vehicle 1 (1190). The operation 1190 may be identical to the operation 1090.

FIG. 22 illustrates an example of the brake device according to one embodiment of the present disclosure cooperating with the steering device in response to the failure of the brake module. The operations illustrated in FIG. 22 are not essential operations, and at least some of these operations may be omitted.

With reference to FIG. 22, a method 1200 is described in which the brake device 100 cooperates with the steering device 40 in response to the failure of the brake module.

The vehicle 1 may include the driving device 20, the steering device 40, and/or the brake device 100. The regenerative braking of the driving device 20 may not be permitted. The brake device 100 may include the brake controller 150 and the brake modules 110, 120, 130, and 140 associated with the wheels 11, 12, 13, and 14.

The brake device 100 may identify the failures of the brake modules 110, 120, 130, and 140 (1210). The operation 1210 may be identical to the operation 1010.

The brake device 100 may identify the driver's required braking torque (1220). The operation 1220 may be identical to the operation 1020.

The brake device 100 may distribute the total required braking torque to the brake modules without failure (1230).

The brake controller 150 may calculate the individual braking torque by dividing the total required braking torque by the number of the brake modules without failure, and transmit the braking signal corresponding to the individual braking torque to the brake modules without failure.

The brake device 100 may identify whether the number of brake modules with failure is the same on the right and left (1240). The operation 1240 may be identical to the operation 1080.

When the number of brake modules with failure is the same on the right and left (YES in 1240), the brake device 100 may operate without the steering request from the steering device 40 (1242). The operation 1242 may be identical to the operation 1082.

When the number of brake modules with failure is not the same on the right and left (NO in 1240), the brake device 100 may request the steering device 40 to steer the vehicle 1 (1250). The operation 1250 may be identical to the operation 1090.

According to one aspect of the present disclosure, the electromechanical brake device and the control method thereof may be provided which may respond to the damage or errors of the actuator or the control/drive circuit through cooperation with other devices of the vehicle. As a result, the robustness of the entire vehicle against damage or errors may be improved.

According to one aspect of the present disclosure, the electromechanical brake device and the control method thereof may be provided which may respond to the damage or errors of an actuator or a control/drive circuit through cooperation with the driving device of the vehicle.

According to one aspect of the present disclosure, the electromechanical brake device and the control method thereof may be provided which may respond to the damage or errors of the actuator or the control/drive circuit through cooperation with the steering device of the vehicle.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A brake device comprising:
a first brake module and a second brake module respectively associated with braking of right side and left side wheels of a first axle of a vehicle;
a third brake module and a fourth brake module respectively associated with braking of right side and left side wheels of a second axle of the vehicle; and
a controller configured to control the first, second, third, and fourth brake modules based on a pedal signal associated with movement of a brake pedal,
wherein the controller is configured to:
based on identifying a failure of at least one of the first, second, third and fourth brake modules, request a driving device of the vehicle to perform regenerative braking of a wheel associated with a with-failure brake module from among the first, second, third, and fourth brake modules and control a braking torque of a without-failure brake module from among the first, second, third and fourth brake modules, and
based on braking torques applied to the left side wheels being different from braking torques applied to the right side wheels, request a steering device of the vehicle to steer the vehicle.

2. The brake device according to claim 1, wherein the controller is configured to:
obtain a driver required braking torque based on the pedal signal,
obtain a maximum regenerative braking torque of the driving device, and
request the driving device to perform the regenerative braking based on whether the driver required braking torque is less than or equal to the maximum regenerative braking torque.

3. The brake device according to claim 2, wherein the controller is configured to request the driving device to apply a regenerative braking torque corresponding to the driver required braking torque to the wheel associated with the with-failure brake module, when the driver required braking torque is less than or equal to the maximum regenerative braking torque.

4. The brake device according to claim 2, wherein the controller is configured to control the without-failure brake module to apply a braking torque corresponding to the driver required braking torque, when the driver required braking torque is less than or equal to the maximum regenerative braking torque.

5. The brake device according to claim 2, wherein the controller is configured to request the driving device to apply a regenerative braking torque corresponding to the maximum regenerative braking torque to the wheel associated with the with-failure brake module, when the driver required braking torque exceeds the maximum regenerative braking torque.

6. The brake device according to claim 2, wherein the controller is configured to control the without-failure brake module to apply a braking torque corresponding to a difference between the driver required braking torque and the maximum regenerative braking torque, when the driver required braking torque exceeds the maximum regenerative braking torque.

7. The brake device according to claim 1, wherein the controller is configured to request the steering device of the vehicle to steer the vehicle, when the with-failure brake module includes two brake modules provided on a same side of the first and second axles.

8. The brake device according to claim 1, wherein the controller is configured not to request the steering device of the vehicle to steer the vehicle, when the with-failure brake module includes two brake modules provided on a different side of the first and second axles.

9. A control method of a brake device including a first brake module and a second brake module respectively associated with braking of right side and left side wheels of a first axle of a vehicle and a third brake module and a fourth brake module respectively associated with braking of right side and left side wheels of a second axle of the vehicle, the control method comprising:
based on identifying a failure of at least one of the first, second, third and fourth brake modules, requesting a driving device of the vehicle to perform regenerative braking of a wheel associated with a with-failure brake module from among the first, second, third, and fourth brake modules and controlling a braking torque of a without-failure brake module from among the first, second, third and fourth brake modules; and
based on braking torques applied to the left side wheels being different from braking torques applied to the right side wheels, requesting a steering device of the vehicle to steer the vehicle.

10. The control method according to claim 9, wherein the requesting the driving device of the vehicle to perform the regenerative braking includes:
obtaining a driver required braking torque based on the pedal signal,
obtaining a maximum regenerative braking torque of the driving device, and
requesting the driving device to perform the regenerative braking based on whether the driver required braking torque is less than or equal to the maximum regenerative braking torque.

11. The control method according to claim 10, wherein the requesting the driving device of the vehicle to perform the regenerative braking includes:
requesting the driving device to apply a regenerative braking torque corresponding to the driver required braking torque to the wheel associated with the with-failure brake module, when the driver required braking torque is less than or equal to the maximum regenerative braking torque.

12. The control method according to claim 10, wherein the controlling of the braking torque of the without-failure brake module includes:
controlling the without-failure brake module to apply a braking torque corresponding to the driver required braking torque, when the driver required braking torque is less than or equal to the maximum regenerative braking torque.

13. The control method according to claim 10, wherein the requesting the driving device of the vehicle to perform the regenerative braking includes:
requesting the driving device to apply a regenerative braking torque corresponding to the maximum regenerative braking torque to the wheel associated with the with-failure brake module, when the driver required braking torque exceeds the maximum regenerative braking torque.

14. The control method according to claim 10, wherein the controlling of the braking torque of the without-failure brake module includes:
controlling the without-failure brake module to apply a braking torque corresponding to a difference between the driver required braking torque and the maximum regenerative braking torque, when the driver required braking torque exceeds the maximum regenerative braking torque.

15. The control method according to claim 9, wherein the requesting of the steering device to steer the vehicle includes:
requesting the steering device of the vehicle to steer the vehicle, when the with-failure brake module includes two brake modules provided on a same side of the first and second axles.

16. The control method according to claim 9, wherein the requesting of the steering device to steer the vehicle includes:
not requesting the steering device of the vehicle to steer the vehicle, when the with-failure brake module includes two brake modules provided on a different side of the first and second axles.

17. A brake device comprising:
a first brake module and a second brake module respectively associated with braking of right side and left side wheels of a first axle of a vehicle;
a third brake module and a fourth brake module respectively associated with braking of right side and left side wheels of a second axle of the vehicle; and
a controller configured to control the first, second, third and fourth brake modules based on a pedal signal associated with movement of a brake pedal,
wherein the controller is configured to:
control, based on identifying a failure of at least one of the first, second, third and fourth brake modules, a braking torque of a without-failure brake module from among the first, second, third and fourth brake modules, and
request, based on braking torques applied to the left side wheels being different from braking torques applied to the right side wheels, a steering device of the vehicle to steer the vehicle.

18. The brake device according to claim 17, wherein the controller is configured to request the steering device of the vehicle to steer the vehicle, based on identifying the failure of at least one of the first, second, third and fourth brake modules.

19. The brake device according to claim 17, wherein the controller is configured to request the steering device of the vehicle to steer the vehicle, when the with-failure brake module includes two brake modules provided on a same side of the first and second axles.

20. The brake device according to claim 17, wherein the controller is configured not to request the steering device of the vehicle to steer the vehicle, when the with-failure brake module includes two brake modules provided on a different side of the first and second axles.
